(19) United States
(12) Patent Application Publication
(10) Pub. No.: US 2022/0014751 A1
(43) Pub. Date: Jan. 13, 2022

(54) METHOD AND DEVICE FOR PROCESSING VIDEO DATA

(71) Applicant: LG ELECTRONICS INC., Seoul (KR)

(72) Inventor: Hyeongmoon JANG, Seoul (KR)

(21) Appl. No.: 17/293,163

(22) PCT Filed: Nov. 14, 2019
(86) PCT No.: PCT/KR2019/015526

§ 371 Date: May 12, 2021

Related U.S. Application Data
(60) Provisional application No. 62/767,508, filed on Nov. 14, 2018.

(51) Int. Cl. H04N 19/132; H04N 19/105; H04N 19/159; H04N 19/46; H04N 19/176

(52) U.S. Cl. CPC H04N 19/132; H04N 19/105; H04N 19/176; H04N 19/46; H04N 19/159

(57) ABSTRACT

An embodiment of the present specification provides a method and device for processing video data. A method for processing video data according to an embodiment of the present specification, may comprise: a step of determining whether a pulse code modulation (PCM) mode in which a sample value of a current block of the video data is transmitted through a bitstream is applied; a step of parsing, on the basis of the PCM mode not being applied, an index associated with a reference line for intra prediction of the current block from the bitstream; and a step of generating a prediction sample of the current block on the basis of a reference sample included in the reference line associated with the index.

### TECHNICAL FIELD

The present disclosure relates to a method and device for processing video data, and more particularly to a method and device for encoding or decoding video data by using intra prediction.

### BACKGROUND ART

A compression encoding means a series of signal processing techniques for transmitting digitized information through a communication line or techniques for storing the information in the form that is suitable for a storage medium. The media including a video, an image, an audio, and the like may be the target for the compression encoding, and particularly, the technique of performing the compression encoding targeted to the video is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design a coding tool for efficiently processing next-generation video content. Particularly, video codec standards after the high efficiency video coding (HEVC) standard require more efficient prediction techniques

### DISCLOSURE

### Technical Problem

Embodiments of the disclosure provide a video data processing method and device that provides intra prediction that uses data resources more efficiently.

Objects of the disclosure are not limited to the foregoing, and other unmentioned objects would be apparent to one of ordinary skill in the art from the following description.

### Technical Solution

According to an embodiment of the disclosure, a method for processing video data may comprise determining whether a pulse code modulation (PCM) mode is applied in which a sample value of a current block of the video data is transmitted via a bitstream, parsing an index related to a reference line for intra prediction of the current block from the bitstream, based on the PCM mode being not applied, and generating a prediction sample of the current block based on a reference sample included in a reference line related to the index.

According to an embodiment, the index may indicate one of a plurality of reference lines positioned within a predetermined distance from the current block.

According to an embodiment, the plurality of reference lines may include a plurality of upper reference lines positioned on a top boundary of the current block or a plurality of reference lines positioned on a left side of a left boundary of the current block.

According to an embodiment, the plurality of reference lines may be included in the same coding tree unit as the current block.

According to an embodiment, determining whether the PCM mode is applied may include identifying a flag indicating whether the PCM mode is applied.

According to an embodiment, the index may be transmitted from an encoding device to a decoding device when the PCM mode is not applied.

According to an embodiment, the current block may correspond to a coding unit or a prediction unit.

According to another embodiment of the disclosure, a device for processing video data comprises a memory storing the video data and a processor coupled with the memory, wherein the processor may be configured to determine whether a pulse code modulation (PCM) mode is applied in which a sample value of a current block of the video data is transmitted via a bitstream, parse an index related to a reference line for intra prediction of the current block from the bitstream, based on the PCM mode being not applied, and generate a prediction sample of the current block based on a reference sample included in a reference line related to the index.

According to another embodiment of the disclosure, there is provided a non-transitory computer-readable medium storing a computer-executable component configured to be executed by one or more processors of a computing device, the computer-executable component configured to determine whether a pulse code modulation (PCM) mode is applied in which a sample value of a current block of the video data is transmitted via a bitstream, parse an index related to a reference line for intra prediction of the current block from the bitstream, based on the PCM mode being not applied, and generate a prediction sample of the current block based on a reference sample included in a reference line related to the index.

### Advantageous Effects

According to an embodiment of the disclosure, it is possible to provide an intra prediction method that efficiently uses data resources by removing redundancy between the syntax of the multiple line reference (MRL) intra prediction and the syntax of the pulse code modulation (PCM) mode in an intra prediction process.

Effects of the disclosure are not limited to the foregoing, and other unmentioned effects would be apparent to one of ordinary skill in the art from the following description.

### DESCRIPTION OF DRAWINGS

The accompany drawings, which are included as part of the detailed description in order to help understanding of the disclosure, provide embodiments of the disclosure and describe the technical characteristics of the disclosure along with the detailed description.

FIG. 1 illustrates an example of a video coding system according to an embodiment of the disclosure.

FIG. 2 is an embodiment to which the disclosure is applied, and is a schematic block diagram of an encoding apparatus for encoding a video/image signal.

FIG. 3 is an embodiment to which the disclosure is applied, and is a schematic block diagram of a decoding apparatus for decoding a video/image signal.

FIG. 4 shows an example of a structural diagram of a content streaming system according to an embodiment of the disclosure.

FIG. 5 illustrates an example of multi-type tree split modes according to an embodiment of the present disclosure.

FIGS. 6 and 7 illustrate an intra prediction-based encoding method according to an embodiment of the disclosure and an example intra prediction unit in an encoding device according to an embodiment of the disclosure.

FIGS. 8 and 9 illustrate an intra prediction-based video/image decoding method according to an embodiment of the disclosure and an example intra prediction unit in a decoding device according to an embodiment of the disclosure.

FIGS. 10 and 11 illustrate example prediction directions of an intra prediction mode which may be applied to embodiments of the disclosure.

FIG. 12 illustrates example reference lines for applying multi-reference line prediction according to an embodiment of the disclosure.

FIG. 13 is a flowchart illustrating an example of processing video data according to an embodiment of the disclosure.

FIG. 14 is a flowchart illustrating an example of encoding video data according to an embodiment of the disclosure.

FIG. 15 is a flowchart illustrating an example of decoding video data according to an embodiment of the disclosure.

FIG. 16 is a block diagram illustrating an example device for processing video data according to an embodiment of the disclosure.

### MODE FOR INVENTION

Hereinafter, preferred embodiments of the disclosure will be described by reference to the accompanying drawings. The description that will be described below with the accompanying drawings is to describe exemplary embodiments of the disclosure, and is not intended to describe the only embodiment in which the disclosure may be implemented. The description below includes particular details in order to provide perfect understanding of the disclosure. However, it is understood that the disclosure may be embodied without the particular details to those skilled in the art. In some cases, in order to prevent the technical concept of the disclosure from being unclear, structures or devices which are publicly known may be omitted, or may be depicted as a block diagram centering on the core functions of the structures or the devices.

In some cases, in order to prevent the technical concept of the disclosure from being unclear, structures or devices which are publicly known may be omitted, or may be depicted as a block diagram centering on the core functions of the structures or the devices.

Further, although general terms widely used currently are selected as the terms in the disclosure as much as possible, a term that is arbitrarily selected by the applicant is used in a specific case. Since the meaning of the term will be clearly described in the corresponding part of the description in such a case, it is understood that the disclosure will not be simply interpreted by the terms only used in the description of the disclosure, but the meaning of the terms should be figured out.

Specific terminologies used in the description below may be provided to help the understanding of the disclosure. Furthermore, the specific terminology may be modified into other forms within the scope of the technical concept of the disclosure. For example, a signal, data, a sample, a picture, a slice, a tile, a frame, a block, etc may be properly replaced and interpreted in each coding process.

Hereinafter, in this specification, a “processing unit” means a unit in which an encoding/decoding processing process, such as prediction, a transform and/or quantization, is performed. A processing unit may be construed as having a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as being a unit for a luma component or a unit for a chroma component. For example, the processing unit may correspond to a coding tree block (CTB), a coding block (CB), a prediction block (PB) or a transform block (TB) for a luma component. Alternatively, a processing unit may correspond to a coding tree block (CTB), a coding block (CB), a prediction block (PB) or a transform block (TB) for a chroma component. Furthermore, the disclosure is not limited thereto, and a processing unit may be construed as a meaning including a unit for a luma component and a unit for a chroma component.

Furthermore, a processing unit is not essentially limited to a square block and may be constructed in a polygon form having three or more vertices.

Furthermore, hereinafter, in this specification, a pixel, a picture element, a coefficient (a transform coefficient or a transform coefficient after a first order transformation) etc. are generally called a sample. Furthermore, to use a sample may mean to use a pixel value, a picture element value, a transform coefficient or the like.

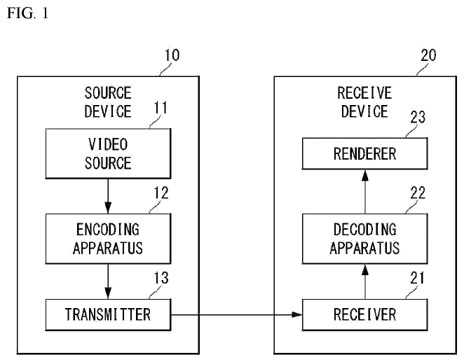

FIG. 1 illustrates an example of a video coding system according to an embodiment of the disclosure.

The video coding system may include a source device 10 and a receive device 20. The source device 10 may transmit encoded video/image information or data to the receive device 20 in a file or streaming format through a storage medium or a network.

The source device 10 may include a video source 11, an encoding apparatus 12, and a transmitter 13. The receive device 20 may include a receiver 21, a decoding apparatus 22 and a renderer 23. The source device may be referred to as a video/image encoding apparatus and the receive device may be referred to as a video/image decoding apparatus. The transmitter 13 may be included in the encoding apparatus 12. The receiver 21 may be included in the decoding apparatus 22. The renderer may include a display and the display may be configured as a separate device or an external component.

The video source 11 may acquire video/image data through a capture, synthesis, or generation process of video/image. The video source may include a video/image capturing device and/or a video/image generating device. The video/image capturing device may include, for example, one or more cameras, a video/image archive including previously captured video/images, and the like. The video/image generating device may include, for example, a computer, a tablet, and a smartphone, and may electronically generate video/image data. For example, virtual video/image data may be generated through a computer or the like, and in this case, a video/image capturing process may be replaced by a process of generating related data.

The encoding apparatus 12 may encode an input video/image. The encoding apparatus 12 may perform a series of procedures such as prediction, transform, and quantization for compression and coding efficiency. The encoded data (encoded video/video information) may be output in a form of a bit stream.

The transmitter 13 may transmit the encoded video/video information or data output in the form of a bit stream to the receiver of the receive device through a digital storage medium or a network in a file or streaming format. The digital storage media may include various storage media such as a universal serial bus (USB), a secure digital (SD), a compact disk (CD), a digital video disk (DVD), Bluray, a hard disk drive (HDD), and a solid state drive (SSD). The transmitter 13 may include an element for generating a media file through a predetermined file format, and may include an element for transmission through a broadcast/communication network. The receiver 21 may extract the bit stream and transmit it to the decoding apparatus 22.

The decoding apparatus 22 may decode video/image data by performing a series of procedures such as dequantization, inverse transform, and prediction corresponding to the operations of the encoding apparatus 12.

The renderer 23 may render the decoded video/image. The rendered video/image may be displayed through the display.

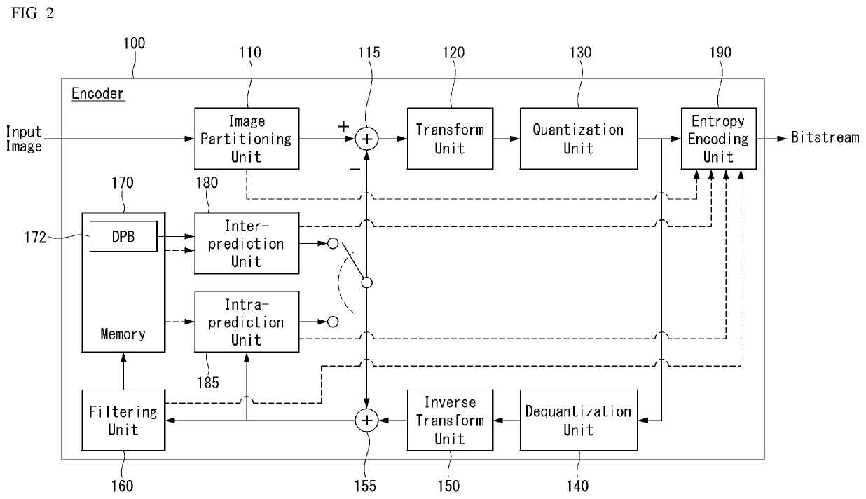

FIG. 2 is an embodiment to which the disclosure is applied, and is a schematic block diagram of an encoding apparatus for encoding a video/image signal. The encoding apparatus of FIG. 2 may correspond to the encoding apparatus 12.

Referring to FIG. 2, an encoding apparatus 100 may be configured to include an image divider 110, a subtractor 115, a transformer 120, a quantizer 130, a dequantizer 140, an inverse transformer 150, an adder 155, a filter 160, a memory 170, an inter predictor 180, an intra predictor 185 and an entropy encoder 190. The inter predictor 180 and the intra predictor 185 may be commonly called a predictor. In other words, the predictor may include the inter predictor 180 and the intra predictor 185. The transformer 120, the quantizer 130, the dequantizer 140, and the inverse transformer 150 may be included in a residual processor. The residual processor may further include the subtractor 115. In one embodiment, the image divider 110, the subtractor 115, the transformer 120, the quantizer 130, the dequantizer 140, the inverse transformer 150, the adder 155, the filter 160, the inter predictor 180, the intra predictor 185 and the entropy encoder 190 may be configured as one hardware component (e.g., an encoder or a processor). Furthermore, the memory 170 may be configured with a hardware component (for example a memory or a digital storage medium) in an embodiment. And, the memory 170 may include a decoded picture buffer (DPB).

The image divider 110 may divide an input image (or picture or frame), input to the encoding apparatus 100, into one or more processing units. For example, the processing unit may be called a coding unit (CU). In this case, the coding unit may be recursively split from a coding tree unit (CTU) or the largest coding unit (LCU) based on a quadtree binary-tree (QTBT) structure. For example, one coding unit may be split into a plurality of coding units of a deeper depth based on a quadtree structure and/or a binary-tree structure. In this case, for example, the quadtree structure may be first applied, and the binary-tree structure may be then applied. Alternatively the binary-tree structure may be first applied. A coding procedure according to the disclosure may be performed based on the final coding unit that is no longer split. In this case, the largest coding unit may be directly used as the final coding unit based on coding efficiency according to an image characteristic or a coding unit may be recursively split into coding units of a deeper depth, if necessary. Accordingly, a coding unit having an optimal size may be used as the final coding unit. In this case, the coding procedure may include a procedure, such as a prediction, transform or reconstruction to be described later. For another example, the processing unit may further include a prediction unit (PU) or a transform unit (TU). In this case, each of the prediction unit and the transform unit may be divided or partitioned from each final coding unit. The prediction unit may be a unit for sample prediction, and the transform unit may be a unit from which a transform coefficient is derived and/or a unit in which a residual signal is derived from a transform coefficient.

A unit may be interchangeably used with a block or an area according to circumstances. In a common case, an M×N block may indicate a set of samples configured with M columns and N rows or a set of transform coefficients. In general, a sample may indicate a pixel or a value of a pixel, and may indicate only a pixel/pixel value of a luma component or only a pixel/pixel value of a chroma component. In a sample, one picture (or image) may be used as a term corresponding to a pixel or pel.

The encoding apparatus 100 may generate a residual signal (residual block or residual sample array) by subtracting a prediction signal (predicted block or prediction sample array), output by the inter predictor 180 or the intra predictor 185, from an input image signal (original block or original sample array). The generated residual signal is transmitted to the transformer 120. In this case, as illustrated, a unit in which the prediction signal (prediction block or prediction sample array) is subtracted from the input image signal (original block or original sample array) within the encoding apparatus 100 may be called the subtractor 115. The predictor may perform prediction on a processing target block (hereinafter referred to as a current block), and may generate a predicted block including prediction samples for the current block. The predictor may determine whether an intra prediction is applied or inter prediction is applied in a current block or a CU unit. The predictor may generate various pieces of information on a prediction, such as prediction mode information as will be described later in the description of each prediction mode, and may transmit the information to the entropy encoder 190. The information on prediction may be encoded in the entropy encoder 190 and may be output in a bit stream form.

The intra predictor 185 may predict a current block with reference to samples within a current picture. The referred samples may be located to neighbor the current block or may be spaced from the current block depending on a prediction mode. In an intra prediction, prediction modes may include a plurality of non-angular modes and a plurality of angular modes. The non-angular mode may include a DC mode and a planar mode, for example. The angular mode may include 33 angular prediction modes or 65 angular prediction modes, for example, depending on a fine degree of a prediction direction. In this case, angular prediction modes that are more or less than the 33 angular prediction modes or 65 angular prediction modes may be used depending on a configuration, for example. The intra predictor 185 may determine a prediction mode applied to a current block using the prediction mode applied to a neighboring block.

The inter predictor 180 may derive a predicted block for a current block based on a reference block (reference sample array) specified by a motion vector on a reference picture. In this case, in order to reduce the amount of motion information transmitted in an inter prediction mode, motion information may be predicted as a block, a sub-block or a sample unit based on the correlation of motion information between a neighboring block and the current block. The motion information may include a motion vector and a reference picture index. The motion information may further include inter prediction direction (L0 prediction, L1 prediction, Bi prediction) information. In the case of inter prediction, a neighboring block may include a spatial neighboring block within a current picture and a temporal neighboring block within a reference picture. A reference picture including a reference block and a reference picture including a temporal neighboring block may be the same or different. The temporal neighboring block may be referred to as a name called a co-located reference block or a co-located CU (colCU). A reference picture including a temporal neighboring block may be referred to as a co-located picture (colPic). For example, the inter predictor 180 may construct a motion information candidate list based on neighboring blocks, and may generate information indicating that which candidate is used to derive a motion vector and/or reference picture index of a current block. An inter prediction may be performed based on various prediction modes. For example, in the case of a skip mode and a merge mode , the inter predictor 180 may use motion information of a neighboring block as motion information of a current block. In the case of the skip mode, unlike the merge mode, a residual signal may not be transmitted. In the case of a motion vector prediction (MVP) mode, a motion vector of a neighboring block may be used as a motion vector predictor. A motion vector of a current block may be indicated by signaling a motion vector difference.

A prediction signal generated through the inter predictor 180 or the intra predictor 185 may be used to generate a reconstructed signal or a residual signal.

The transformer 120 may generate transform coefficients by applying a transform scheme to a residual signal. For example, the transform scheme may include at least one of a discrete cosine transform (DCT), a discrete sine transform (DST), a Karhunen-Loève transform (KLT), a graph-based transform (GBT), or a conditionally non-linear transform (CNT). In this case, the GBT means a transform obtained from a graph if relation information between pixels is represented as the graph. The CNT means a transform obtained based on a prediction signal generated u sing all of previously reconstructed pixels. Furthermore, a transform process may be applied to pixel blocks having the same size of a square form or may be applied to blocks having variable sizes not a square form.

The quantizer 130 may quantize transform coefficients and transmit them to the entropy encoder 190. The entropy encoder 190 may encode a quantized signal (information on quantized transform coefficients) and output it in a bit stream form. The information on quantized transform coefficients may be called residual information. The quantizer 130 may re-arrange the quantized transform coefficients of a block form in one-dimensional vector form based on a coefficient scan sequence, and may generate information on the quantized transform coefficients based on the quantized transform coefficients of the one-dimensional vector form. The entropy encoder 190 may perform various encoding methods, such as exponential Golomb, context-adaptive variable length coding (CAVLC), and context-adaptive binary arithmetic coding (CABAC). The entropy encoder 190 may encode information (e.g., values of syntax elements) necessary for video/image reconstruction in addition to the quantized transform coefficients together or separately. The encoded information (e.g., encoded video/image information) may be transmitted or stored in a network abstraction layer (NAL) unit unit in the form of a bit stream. The bit stream may be transmitted over a network or may be stored in a digital storage medium. In this case, the network may include a broadcast network and/or a communication network. The digital storage medium may include various storage media, such as a USB, an SD, a CD, a DVD, Blueray, an HDD, and an SSD. A transmitter (not illustrated) that transmits a signal output by the entropy encoder 190 and/or a storage (not illustrated) for storing the signal may be configured as an internal/external element of the encoding apparatus 100, or the transmitter may be an element of the entropy encoder 190.

Quantized transform coefficients output by the quantizer 130 may be used to generate a prediction signal. For example, a residual signal may be reconstructed by applying de-quantization and an inverse transform to the quantized transform coefficients through the dequantizer 140 and the inverse transformer 150 within a loop. The adder 155 may add the reconstructed residual signal to a prediction signal output by the inter predictor 180 or the intra predictor 185, so a reconstructed signal (reconstructed picture, reconstructed block or reconstructed sample array) may be generated. A predicted block may be used as a reconstructed block if there is no residual for a processing target block as in the case where a skip mode has been applied. The adder 155 may be called a reconstructor or a reconstruction block generator. The generated reconstructed signal may be used for the intra prediction of a next processing target block within a current picture, and may be used for the inter prediction of a next picture through filtering as will be described later.

The filter 160 can improve subjective/objective picture quality by applying filtering to a reconstructed signal. For example, the filter 160 may generate a modified reconstructed picture by applying various filtering methods to the reconstructed picture. The modified reconstructed picture may be stored in the DPB 170. The various filtering methods may include deblocking filtering, a sample adaptive offset, an adaptive loop filter, and a bilateral filter, for example. The filter 160 may generate various pieces of information for filtering as will be described later in the description of each filtering method, and may transmit them to the entropy encoder 190. The filtering information may be encoded by the entropy encoder 190 and output in a bit stream form.

The modified reconstructed picture transmitted to the DPB 170 may be used as a reference picture in the inter predictor 180. The encoding apparatus can avoid a prediction mismatch in the encoding apparatus 100 and a decoding apparatus and improve encoding efficiency if inter prediction is applied.

The DPB 170 may store a modified reconstructed picture in order to use the modified reconstructed picture as a reference picture in the inter predictor 180.

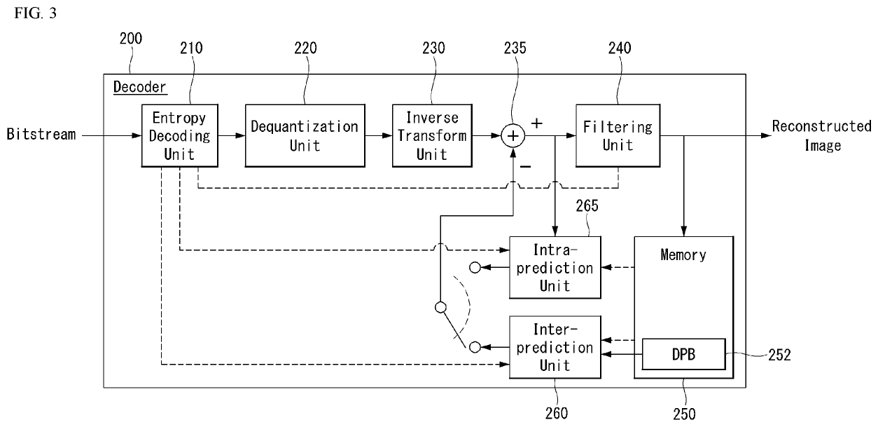

FIG. 3 is an embodiment to which the disclosure is applied, and is a schematic block diagram of a decoding apparatus for decoding a video/image signal. The decoding apparatus of FIG. 3 may correspond to the decoding apparatus of FIG. 1.

Referring to FIG. 3, the decoding apparatus 200 may be configured to include an entropy decoder 210, a dequantizer 220, an inverse transformer 230, an adder 235, a filter 240, a memory 250, an inter predictor 260 and an intra predictor 265. The inter predictor 260 and the intra predictor 265 may be collectively called a predictor. That is, the predictor may include the inter predictor 180 and the intra predictor 185. The dequantizer 220 and the inverse transformer 230 may be collectively called as residual processor. That is, the residual processor may include the dequantizer 220 and the inverse transformer 230. The entropy decoder 210, the dequantizer 220, the inverse transformer 230, the adder 235, the filter 240, the inter predictor 260 and the intra predictor 265 may be configured as one hardware component (e.g., the decoder or the processor) according to an embodiment. Furthermore, the decoded picture buffer 250 may be configured with a hardware component (for example a memory or a digital storage medium) in an embodiment. The memory 250 may include the DPB 175, and may be configured by a digital storage medium.

When a bit stream including video/image information is input, the decoding apparatus 200 may reconstruct an image in accordance with a process of processing video/image information in the encoding apparatus of FIG. 2. For example, the decoding apparatus 200 may perform decoding using a processing unit applied in the encoding apparatus. Accordingly, a processing unit for decoding may be a coding unit, for example. The coding unit may be split from a coding tree unit or the largest coding unit depending on a quadtree structure and/or a binary-tree structure. Furthermore, a reconstructed image signal decoded and output through the decoding apparatus 200 may be played back through a playback device.

The decoding apparatus 200 may receive a signal, output by the encoding apparatus of FIG. 1, in a bit stream form. The received signal may be decoded through the entropy decoder 210. For example, the entropy decoder 210 may derive information (e.g., video/image information) for image reconstruction (or picture reconstruction) by parsing the bit stream. For example, the entropy decoder 210 may decode information within the bit stream based on a coding method, such as exponential Golomb encoding, CAVLC or CABAC, and may output a value of a syntax element for image reconstruction or quantized values of transform coefficients regarding a residual. More specifically, in the CABAC entropy decoding method, a bin corresponding to each syntax element may be received from a bit stream, a context model may be determined using decoding target syntax element information and decoding information of a neighboring and decoding target block or information of a symbol/bin decoded in a previous step, a probability that a bin occurs may be predicted based on the determined context model, and a symbol corresponding to a value of each syntax element may be generated by performing arithmetic decoding on the bin. In this case, in the CABAC entropy decoding method, after a context model is determined, the context model may be updated using information of a symbol/bin decoded for the context model of a next symbol/bin. Information on a prediction among information decoded in the entropy decoder 2110 may be provided to the predictor (inter predictor 260 and intra predictor 265). Parameter information related to a residual value on which entropy decoding has been performed in the entropy decoder 210, that is, quantized transform coefficients, may be input to the dequantizer 220. Furthermore, information on filtering among information decoded in the entropy decoder 210 may be provided to the filter 240. Meanwhile, a receiver (not illustrated) that receives a signal output by the encoding apparatus may be further configured as an internal/external element of the decoding apparatus 200 or the receiver may be an element of the entropy decoder 210.

The dequantizer 220 may de-quantize quantized transform coefficients and output transform coefficients. The dequantizer 220 may re-arrange the quantized transform coefficients in a two-dimensional block form. In this case, the re-arrangement may be performed based on a coefficient scan sequence performed in the encoding apparatus. The dequantizer 220 may perform de-quantization on the quantized transform coefficients using a quantization parameter (e.g., quantization step size information), and may obtain transform coefficients.

The inverse transformer 230 may output a residual signal (residual block or residual sample array) by applying inverse-transform to transform coefficients.

The predictor may perform a prediction on a current block, and may generate a predicted block including prediction samples for the current block. The predictor may determine whether an intra prediction is applied or inter prediction is applied to the current block based on information on a prediction, which is output by the entropy decoder 210, and may determine a detailed intra/inter prediction mode.

The intra predictor 265 may predict a current block with reference to samples within a current picture. The referred samples may be located to neighbor a current block or may be spaced apart from a current block depending on a prediction mode. In an intra prediction, prediction modes may include a plurality of non-angular modes and a plurality of angular modes. The intra predictor 265 may determine a prediction mode applied to a current block using a prediction mode applied to a neighboring block.

The inter predictor 260 may derive a predicted block for a current block based on a reference block (reference sample array) specified by a motion vector on a reference picture. In this case, in order to reduce the amount of motion information transmitted in an inter prediction mode, motion information may be predicted as a block, a sub-block or a sample unit based on the correlation of motion information between a neighboring block and the current block. The motion information may include a motion vector and a reference picture index. The motion information may further include inter prediction direction (L0 prediction, L1 prediction, Bi prediction) information. In the case of inter prediction, a neighboring block may include a spatial neighboring block within a current picture and a temporal neighboring block within a reference picture. For example, the inter predictor 260 may configure a motion information candidate list based on neighboring blocks, and may derive a motion vector and/or reference picture index of a current block based on received candidate selection information. An inter prediction may be performed based on various prediction modes. Information on the prediction may include information indicating a mode of inter prediction for a current block.

The adder 235 may generate a reconstructed signal (reconstructed picture, reconstructed block or reconstructed sample array) by adding an obtained residual signal to a prediction signal (predicted block or prediction sample array) output by the inter predictor 260 or the intra predictor 265. A predicted block may be used as a reconstructed block if there is no residual for a processing target block as in the case where a skip mode has been applied.

The adder 235 may be called a reconstructor or a reconstruction block generator. The generated reconstructed signal may be used for the intra prediction of a next processing target block within a current picture, and may be used for the inter prediction of a next picture through filtering as will be described later.

The filter 240 can improve subjective/objective picture quality by applying filtering to a reconstructed signal. For example, the filter 240 may generate a modified reconstructed picture by applying various filtering methods to a reconstructed picture, and may transmit the modified reconstructed picture to the DPB 250. The various filtering methods may include deblocking filtering, a sample adaptive offset SAO, an adaptive loop filter ALF, and a bilateral filter, for example.

A reconstructed picture transmitted (modified) to the decoded picture buffer 250 may be used as a reference picture in the inter predictor 260.

In the disclosure, the embodiments described in the filter 160, inter predictor 180 and intra predictor 185 of the encoding apparatus 100 may be applied to the filter 240, inter predictor 260 and intra predictor 265 of the decoding apparatus 200, respectively, identically or in a correspondence manner.

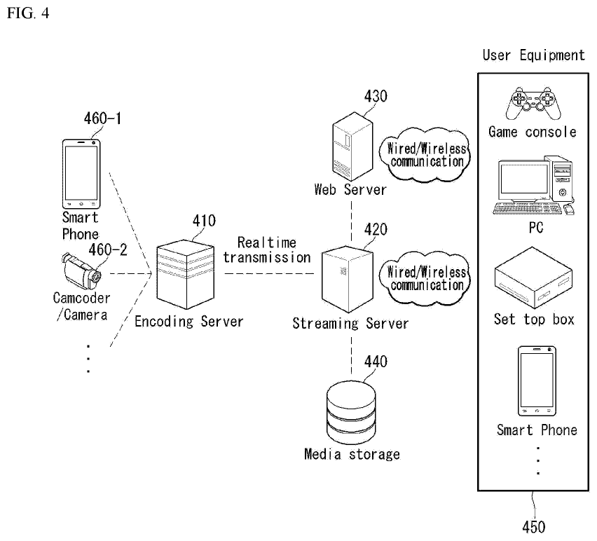

FIG. 4 shows a structural diagram of a content streaming system according to an embodiment of the disclosure.

The content streaming system to which the disclosure is applied may largely include an encoding server 410, a streaming server 420, a web server 430, a media storage 440, a user device 450, and a multimedia input device 460.

The encoding server 410 may compress the content input from multimedia input devices such as a smartphone, camera, camcorder, etc. into digital data to generate a bit stream and transmit it to the streaming server 420. As another example, when the multimedia input devices 460 such as the smartphone, camera, and camcorder directly generate a bit stream, the encoding server 410 may be omitted.

The bit stream may be generated by an encoding method or a bit stream generation method to which the disclosure is applied, and the streaming server 420 may temporarily store the bit stream in the process of transmitting or receiving the bit stream.

The streaming server 420 transmits multimedia data to the user device 450 based on a user request through the web server 430, and the web server 430 serves as an intermediary to inform the user of what service is present. When a user requests a desired service through the web server 430, the web server 430 delivers it to the streaming server 420, and the streaming server 420 transmits multimedia data to the user. At this time, the content streaming system may include a separate control server, in which case the control server serves to control commands/responses between devices in the content streaming system.

The streaming server 420 may receive content from the media storage 440 and/or the encoding server 410. For example, the streaming server 420 may receive content in real time from the encoding server 410. In this case, in order to provide a smooth streaming service, the streaming server 420 may store the bit stream for a predetermined time.

For example, the user device 450 may include a mobile phone, a smart phone, a laptop computer, a terminal for digital broadcasting, a personal digital assistant PDA, a portable multimedia player PMP, a navigation terminal, a slate PC, a tablet PC, an ultra book, a wearable device (for example, a smart watch, a smart glass, a head mounted display HMD, a digital TV, a desktop computer, and digital signage.

Each server in the content streaming system may operate as a distributed server, and in this case, data received from each server may be processed in a distributed manner.

Block Partitioning

A video/image coding method according to the present disclosure may be performed based on various detailed technologies, and each of the detailed technologies is schematically described as follows. It is evident to those skilled in the art that the technologies described below may be associated with related procedures, such as prediction, residual processing (transform, quantization, etc.), syntax element coding, filtering, and partitioning/splitting in video/image encoding/decoding procedures that have been described above and/or are to be described later.

Respective pictures consituting the video data may be divided into a sequence of coding tree units (CTUs). The CTU may correspond to a coding tree block (CTB). Alternatively, the CTU may include a coding tree block of luma samples and two coding tree blocks of chroma samples corresponding to the luma samples. In other words, with respect to a picture including a three-sample array, the CTU may include an N×N block of luma samples and two corresponding blocks of chroma samples.

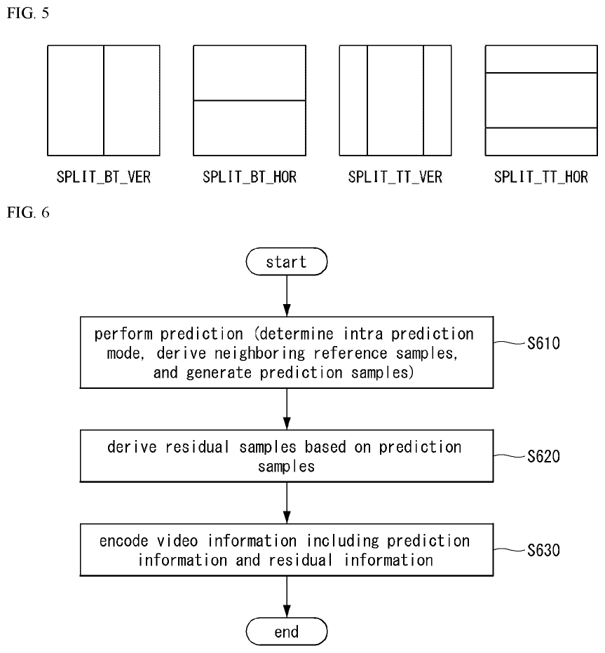

FIG. 5 illustrates an example of multi-type tree split modes according to an embodiment of the present disclosure.

A CTU may be split into CUs based on a quad-tree (QT) structure. The quad-tree structure may also be called as a quaternary tree structure. This is for incorporating various local characteristics. Meanwhile, in the present disclosure, a CTU may be split based on a multi-type tree structure split including a binary-tree (BT) and a ternary-tree (TT) in addition to a quad-tree.

The four splitting types illustrated in FIG. 5 may include vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

Leaf nodes of the multi-type tree structure may correspond to CUs. Prediction and transform procedures may be performed on each CU. In the present disclosure, in general, a CU, a PU, and a TU may have the same block size. However, if a maximum supported transform length is smaller than the width or height of a color component of a CU, a CU and a TU may have different block sizes.

In another example, the CU may be divided in a different way from the QT structure, the BT structure, or the TT structure. That is, unlike the CU of a lower depth is divided into ¼ size of the CU of a upper depth according to the QT structure, or the CU of the lower depth is divided into ½ size of the CU of the upper depth according to the BT structure, or the CU of the lower depth is divided into ½ or ¼ size of the CU of the upper depth according to the TT structure, the CU of the lower depth may be divided into ⅕, ⅓, ⅜, ⅗, ⅔ or ⅝ size of the CU of the upper depth depending on the case. The method of dividing the CU is not limited thereto.

Prediction

In order to reconstruct a current processing unit on which decoding is performed, a current picture including a current processing unit or a decoded part of other pictures may be used.

In the reconstruction, if only the current picture is used, that is, a picture (slice) on which only intra prediction is performed may be denoted as an intra picture or an I-picture (I-slice). A picture (slice) using one motion vector and reference index in order to predict each unit may be denoted as a prediction picture or a P-picture (P-slice). A picture (slice) using two or more motion vectors and reference indices may be denoted a pair prediction picture or a B-picture (B-slice).

Inter prediction means a prediction method of deriving a sample value of a current block based on a data element (e.g., sample value or motion vector) of a picture other than a current picture. That is, inter prediction means a method of predicting a sample value of a current block by referring to reconstructed regions of another reconstructed picture other than a current picture.

Hereinafter, intra prediction is more specifically described.

Intra Prediction

Intra prediction refers to a prediction method of deriving the sample value of the current block from the data elements (e.g., sample value) of the same decoded picture (or slice). That is, intra prediction refers to a method of predicting the sample value of the current block by referring to reconstructed regions in the current picture.

Intra prediction may represent prediction that generates a prediction sample for the current block based on a reference sample outside the current block in the picture to which the current block belongs (hereinafter, referred to as the current picture).

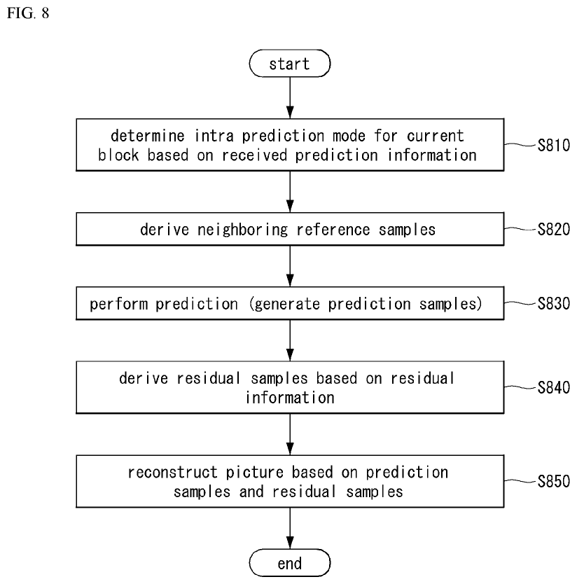

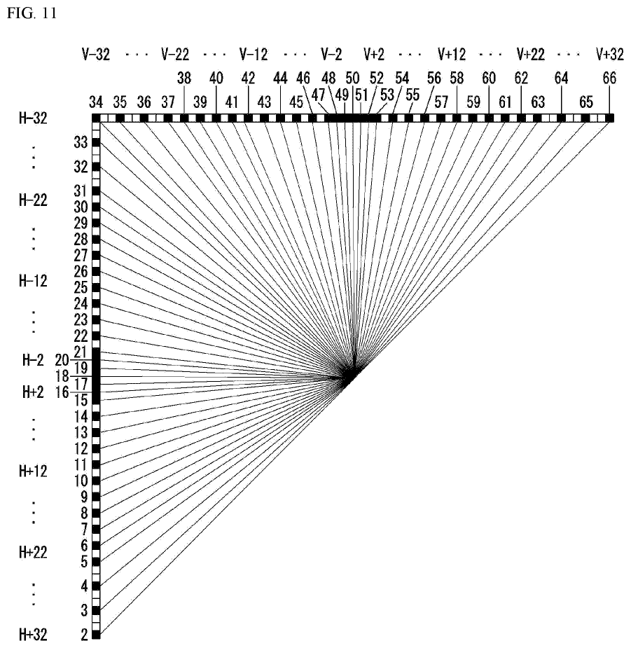

Embodiments of the disclosure describe detailed techniques for the prediction method described in connection with FIGS. 2 and 3 above, and the embodiments of the disclosure may correspond to the intra prediction-based video/image encoding method of FIG. 11 and the device of the intra prediction unit 185 in the encoding device 100 of FIG. 7, as described below. Further, the embodiments of the disclosure may correspond to the intra prediction-based video/image decoding method for FIG. 8 and the device of the intra prediction unit 265 in the decoding device 200 of FIG. 9, as described below. The data encoded by FIGS. 11 and 13 may be stored in a memory included in the encoding device 100 or the decoding device 200 or a memory functionally coupled with the encoding device 100 or the decoding device 200, in the form of a bitstream.

When intra prediction is applied to the current block, neighboring reference samples to be used for intra prediction of the current block may be derived. The neighboring reference samples of the current block may include a total of 2×nH samples including the sample adjacent to the left boundary of the current block with a size of nW×nH and the samples adjacent to the bottom left side, a total of 2×nW samples including the sample adjacent to the top boundary of the current block and the samples adjacent to the top right side, and one sample adjacent to the top left side of the current block. Alternatively, the neighboring reference samples of the current block may include a plurality of rows of top neighboring samples and a plurality of rows of left neighboring samples. The neighboring reference samples of the current block may include samples positioned on the left or right vertical lines adjacent to the current block and samples positioned on the top or bottom horizontal lines.

However, some of the neighboring reference samples of the current block have not yet been decoded or may not be available. In this case, the decoding device 200 may configure neighboring reference samples to be used for prediction by substituting available samples for unavailable samples. Alternatively, the decoder may configure the neighboring reference samples to be used for prediction via interpolation of available samples. For example, the samples positioned on the vertical line adjacent to the right side of the current block and the samples positioned on the horizontal line adjacent to the bottom of the current block may be substituted or configured via interpolation based on the samples positioned on the top horizontal line of the current block and the samples positioned on the left vertical line of the current block.

Where the neighboring reference samples are derived, i) prediction samples may be derived based on the average or interpolation of the neighboring reference samples of the current block, and ii) a prediction sample may be derived based on the reference sample present in a specific (prediction) direction for the prediction sample among the neighboring reference samples of the current block. The prediction mode i) may be denoted a non-directional prediction mode or non-angular prediction mode, and the prediction mode ii) may be denoted a directional prediction mode or angular prediction mode. The prediction sample may be generated by interpolation between a first neighboring sample positioned in the prediction direction of the intra prediction mode of the current block, with respect to the prediction sample of the current block among the neighboring reference samples and a second neighboring sample positioned in the direction opposite to the prediction direction. The prediction scheme which is based on linear interpolation between the reference samples positioned in the prediction direction, with respect to the prediction samples of the current block, and positioned in the direction opposite to the prediction direction may be denoted linear interpolation interprediction (LIP). Further, a temporary prediction sample of the current block may be derived based filtered neighboring reference samples, and the prediction sample of the current block may be derived by the weighted-sum of the temporary prediction samples and at least one reference sample derived according to intra prediction mode among existing neighboring reference samples, i.e., filtered neighboring reference samples. The prediction via the weighted sum of the plurality of samples may be denoted position dependent intra prediction combination (PDPC).

Meanwhile, post-filtering may be performed on the derived prediction sample if necessary. Specifically, the intra prediction procedure may include an intra prediction mode determination step, a neighbor reference sample derivation step, and an intra prediction mode-based prediction sample derivation step and, if necessary, include a post-filtering step on the derived prediction sample.

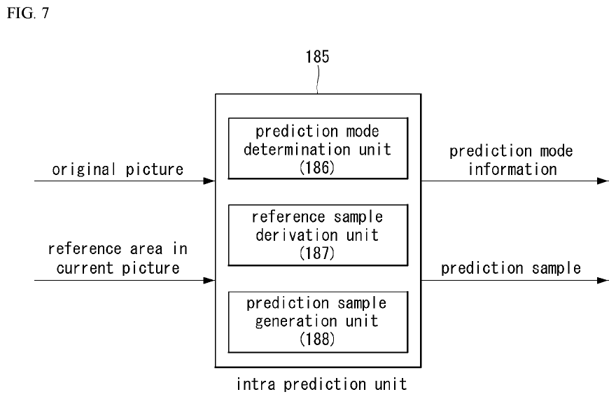

The intra prediction-based video encoding procedure and the intra prediction unit 185 in the encoding device 100 may be expressed as illustrated in FIGS. 6 and 7.

FIGS. 6 and 7 illustrate an intra prediction-based encoding method according to an embodiment of the disclosure and an example intra prediction unit 185 in an encoding device 100 according to an embodiment of the disclosure.

In FIG. 6, step S610 may be performed by the intra prediction unit 185 of the encoding device 100, and steps 5620 and 5630 may be performed by a residual processing unit. Specifically, step S620 may be performed by a subtraction unit 115 of the encoding device 100, and step S630 may be performed by an entropy encoding unit 190 using the residual information derived by the residual processing unit and the prediction information derived by the intra prediction unit 185. The residual information is information for residual samples and may include information for quantized transform coefficients for the residual samples.

As described above, the residual samples may be derived as transform coefficients through a transform unit 120 of the encoding device 100, and the derived transform coefficients may be derived as quantized transform coefficients through a quantization unit 130. The information for the quantized transform coefficients may be encoded by an entropy encoding unit 190 through a residual coding procedure.

In step S610, the encoding device 100 may perform intra prediction on the current block. The encoding device 100 determines an intra prediction mode for the current block, derives neighboring reference samples of the current block, and generates prediction samples in the current block based on the intra prediction mode and the neighboring reference samples. Here, the procedures of determining the intra prediction mode, deriving neighboring reference samples, and generating prediction samples may be performed simultaneously or sequentially. For example, the intra prediction unit 185 of the encoding device 100 may include a prediction mode determination unit 186, a reference sample derivation unit 187, and a prediction sample generation unit 188. The prediction mode determination unit 186 may determine the intra prediction mode for the current block, the reference sample derivation unit 187 may derive the neighboring reference samples of the current block, and the prediction sample generation unit 188 may derive the motion sample of the current block. Meanwhile, although not shown, when a prediction sample filtering procedure described below is performed, the intra prediction unit 185 may further include a prediction sample filter unit (not shown). The encoding device 100 may determine a prediction mode to be applied to the current block among a plurality of intra prediction modes. The encoding device 100 may compare rate-distortion costs (RD costs) for intra prediction modes and determine an optimal intra prediction mode for the current block.

Meanwhile, the encoding device 100 may perform filtering on the prediction sample. Filtering on the prediction sample may be referred to as post filtering. Filtering may be performed on some or all of the prediction samples by a filtering procedure on the prediction samples. In some cases, prediction sample filtering may be omitted.

In step S620, the encoding device 100 may generate a residual sample for the current block based on the (filtered) prediction sample. Thereafter, in step S630, the encoder 100 may encode video data including prediction mode information including an intra prediction mode and information for residual samples. The encoded video data may be output in the form of a bitstream. The output bitstream may be transferred to a decoding device 200 via a network or a storage medium.

Meanwhile, the encoding device 100 as described above may generate a reconstructed picture including reconstructed samples and a reconstructed block based on reference samples and residual samples. The derivation of the reconstructed picture by the encoding device 100 is to derive the same prediction result as that performed by the decoding device 200 in the encoding device 100, thereby enhancing coding efficiency. Furthermore, a subsequent procedure, such as in-loop filtering, may be performed on the reconstructed picture.

FIGS. 8 and 9 illustrate an intra prediction-based video/image decoding method according to an embodiment of the disclosure and an example intra prediction unit 265 in a decoding device 200 according to an embodiment of the disclosure.

Referring to FIGS. 8 and 9, the decoding device 200 may perform operations corresponding to the operations performed by the encoding device 100. The decoding device 200 may derive a prediction sample by performing prediction on the current block based on the received prediction information.

Specifically, in step S810, the decoding device 200 may determine an intra prediction mode for the current block based on the prediction mode information obtained from the encoding device 100. In step S820, the decoding device 200 may derive a neighboring reference sample of the current block. In step S830, the decoding device 200 may generate a prediction sample in the current block based on the intra prediction mode and neighboring reference samples. Further, the decoding device 200 may perform a prediction sample filtering procedure, and the prediction sample filtering procedure may be referred to as post filtering. Some or all of the prediction samples may be filtered by the prediction sample filtering procedure. In some cases, the prediction sample filtering procedure may be omitted.

In step S840, the decoding device 200 may generate a residual sample based on the residual information obtained from the encoding device 100. In step S850, the decoding device 200 may generate reconstructed samples for the current block based on (filtered) prediction samples and residual samples and generate a reconstructed picture using the generated reconstructed samples.

Here, the intra prediction unit 265 of the decoding device 200 may include a prediction mode determination unit 266, a reference sample derivation unit 267, and a prediction sample generation unit 268. The prediction mode determination unit 266 may determine an intra prediction mode of the current block based on the prediction mode generated by the prediction mode determination unit 186 of the encoding device 100, the reference sample derivation unit 267 may derive neighboring reference samples of the current block, and the prediction sample generation unit 268 may generate a prediction sample of the current block. Meanwhile, although not shown, when a prediction sample filtering procedure described below is performed, the intra prediction unit 265 may further include a prediction sample filter unit (not shown).

The prediction mode information used for prediction may include a flag (e.g., prev_intra_luma_pred_flag) for indicating whether the most probable mode (MPM) is applied to the current block or the remaining mode is applied. When the MPM is applied to the current block, the prediction mode information may further include an index (mpm_idx) indicating one of intra prediction mode candidates (MPM candidates). The intra prediction mode candidates (MPM candidates) may be configured of an MPM candidate list or an MPM list. Further, when MPM is not applied to current block, the prediction mode information may further include remaining mode information (example, rem_intra_luma_pred_mpde) indicating one of the remaining intra prediction modes except for intra prediction mode candidates (MPM candidates).

Meanwhile, the decoding device 200 may determine an intra prediction mode of the current block based on the prediction information. The prediction mode information may be encoded and decoded through a coding method described below. For example, the prediction mode information may be encoded or decoded through entropy coding (e.g., CABAC or CAVLC) based on a truncated binary code.

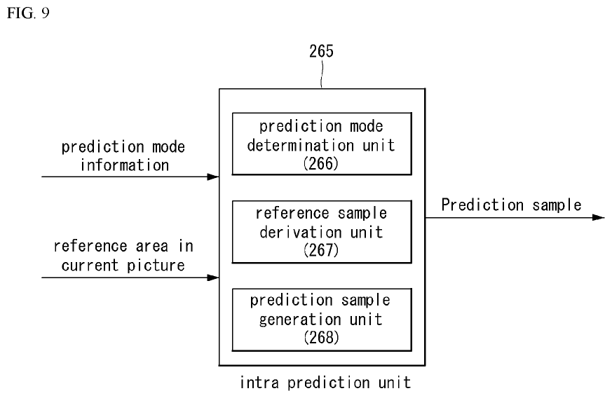

FIGS. 10 and 11 illustrate example prediction directions of an intra prediction mode which may be applied to embodiments of the disclosure.

Referring to FIG. 10, intra prediction modes may include two non-directional intra prediction modes and 33 mode intra prediction modes. The non-directional intra prediction modes may include a planar intra prediction mode and a DC intra prediction mode, and the directional intra prediction modes may include intra prediction modes no. 2 to no. 34. The planar intra prediction mode may be referred to as a planner mode, and the DC intra prediction mode may be referred to as a DC mode.

Meanwhile, to capture an arbitrary edge direction presented in a natural video, the directional intra prediction modes may include 65 as illustrated in FIG. 11 instead of 33 directional intra prediction modes of FIG. 10. In FIG. 11, non-directional intra prediction modes may include a planar mode and a DC mode, and directional intra prediction modes may include intra prediction modes no. 2 to no. 66. As illustrated in FIG. 11, the extended directional intra prediction may be applied to blocks of all sizes, and may be applied to both a luma component and a chroma component.

Further, the intra prediction modes may include two non-directional intra prediction modes and 129 directional intra prediction modes. Here, the non-directional intra prediction modes may include a planar mode and a DC mode, and the directional intra prediction modes may include intra prediction modes no. 2 to no. 130.

MPM Candidate List Configuration

When block division is performed on an image, a current block to be coded and a neighboring block may have similar image characteristics. Therefore, it is highly probable that the current block and the neighboring block have the same or similar intra prediction modes. Accordingly, the encoding device 100 may use the intra prediction mode of the neighboring block to encode the intra prediction mode of the current block.

For example, the encoding device 100 may configure an MPM list for the current block. The MPM list may be referred to as an MPM candidate list. Here, MPM refers to a mode used to enhance coding efficiency considering similarity between the current block and the neighboring block during intra prediction mode coding. In this case, to keep the complexity of generating the MPM list low, a method for configuring an MPM list including three MPMs may be used. When the intra prediction mode for the current block is not included in the MPM list, the remaining mode may be used. In this case, the remaining mode includes 64 remaining candidates, and remaining intra prediction mode information indicating one of the 64 remaining candidates may be signaled. For example, the remaining intra prediction mode information may include a 6-bit syntax element (e.g., rem_intra_luma_pred_mode syntax element).

MRL (Multi-Reference Line Intra Prediction)

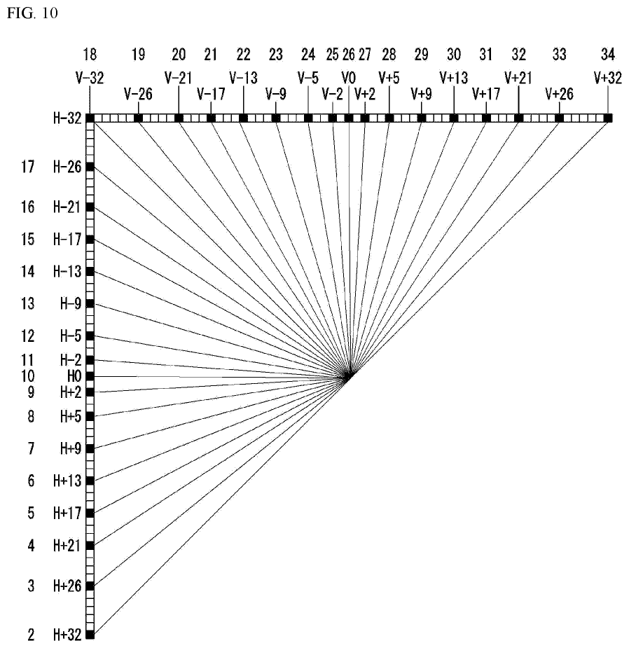

FIG. 12 illustrates example reference lines for applying multi-reference line prediction according to an embodiment of the disclosure.

In general intra picture prediction, directly neighboring samples are used as reference samples for prediction. The MRL extends the existing intra prediction to use neighboring samples having one or more (e.g., 1 to 3) sample distances from the left and upper sides of the current prediction block. Conventional directly neighboring reference sample lines and extended reference lines are illustrated in FIG. 24. In FIG. 25, mrl_idx indicates which line is used for intra prediction of a CU with respect to intra prediction modes (e.g., directional or non-directional prediction modes).

The syntax for performing prediction considering MRL may be configured as illustrated in Table 1.

TABLE 1

coding_unit[ x0, y0, cbWidth, cbHeight, treeType ) {

if( slice_type != I ) {

cu_skip_flag[ x0 ][ y0 ]
if( cu_skip_flag[ x0 ][ y0 ] == 0 )

pred_mode_flag

}
if( CuPredMode[ x0 ][ y0 ] == MODE_INTRA ) {

if( treeType == SINGLE_TREE ∥ treeType ==
DUAL_TREE_LUMA ) {

if( ( y0% CtbSizeY ) > 0 )

intra_luma_ref_idx[ x0 ][ y0 ] ...

if (intra_luma_ref_idx[ x0 ][ y0 ] == 0)

intra_luma_mpm_flag[ x0 ][ y0 ]

if( intra_luma_mpm_flag[ x0 ][ y0 ] )

intra_luma_mpm_idx[ x0 ][ y0 ]

else

intra_luma_mpm_remainder[ x0 ][ y0 ]

}

...
}

In Table 1, intra_luma_ref_idx[x0][y0] may indicate an intra reference line index (IntraLumaRefLineIdx[x0][y0]) specified by Table 2 below. (intra_luma_ref_idx[x0][y0] specifies the intra reference line index IntraLumaRefLineIdx[x0][y0] as specified in Table 8).

If intra_luma_ref_idx[x0][y0] does not exist, it may be inferred as 0. (When intra_luma_ref_idx[x0][y0] is not present it is inferred to be equal to 0).

intra_luma_ref_idx may be referred to as a (intra) reference sample line index or mrl_idx. Also, intra_luma_ref_idx may be referred to as intra_luma_ref_line_idx.

TABLE 2

| intra_luma_ref_idx[ x0 ][ y0 ] | IntraLumaRefLineIdx[ x0 ][ y0 ] |
|---|---|
| 0 | 0 |
| 1 | 1 |
| 2 | 3 |

If intra_luma_mpm_flag[x0][y0] does not exist, it may be inferred as 1.

As illustrated in FIG. 12, a plurality of reference lines near the coding unit for intra prediction according to an embodiment of the disclosure may include a plurality of upper reference lines positioned above the top boundary of the coding unit or a plurality of left reference lines positioned on the left boundary of the coding unit.

When intra prediction is performed on the current block, prediction on the luma component block (luma block) of the current block and prediction on the chroma component block (chroma block) may be performed, in which case the intra prediction mode for the chroma component (chroma block) may be set separately from the intra prediction mode for the luma component (luma block).

For example, the intra prediction mode for the chroma component may be indicated based on intra chroma prediction mode information, and the intra chroma prediction mode information may be signaled in the form of an intra_chroma_pred_mode syntax element. For example, the intra chroma prediction mode information may indicate one of a planar mode, a DC mode, a vertical mode, a horizontal mode, a direct mode (DM), and a linear mode (LM). Here, the planar mode may represent a 0th intra prediction mode, the DC mode a 1st intra prediction mode, the vertical mode a 26th intra prediction mode, and the horizontal mode a 10th intra prediction mode.

Meanwhile, the DM and LM are dependent intra prediction modes for predicting the chroma block using information for the luma block. The DM may indicate a mode in which an intra prediction mode identical to the intra prediction mode for the luma component is applied as the intra prediction mode for the chroma component. Further, the DM may indicate an intra prediction mode that uses samples derived by applying at least one LM parameter to samples subsampled of the reconstructed samples of the luma block during the process of generating the prediction block for the chroma block, as prediction samples of the chroma block.

The embodiments described below relate to pulse code modulation (PCM) and multi reference line (MRL) in an intra prediction process. MRL is a method for using lines of one or more reference samples (multiple reference sample lines) according to the prediction mode in intra prediction. In the MRL, an index indicating which reference line index is to be referenced for performing prediction is signaled through a bitstream. PCM is a method for transmitting the value of a decoded pixel through a bitstream unlike the method for performing intra prediction based on prediction mode. In other words, when the PCM mode is applied, prediction and transform for a target block are not performed, and thus, the intra prediction mode or other syntax is not signaled through the bitstream. The PCM mode may be referred to as a delta pulse code modulation (DPCM) mode or a block-based delta pulse code modulation (BDPCM) mode.

However, in VTM (VVC Test Model)-3.0, as illustrated in Tables 3 and 4 below, a reference line index syntax (intra_luma_ref_idx) for MRL is signaled earlier than the PCM mode syntax and, therefore, redundancy occurs.

In other words, referring to the coding unit syntax of Table 3 below, the reference line index (intra_luma_ref_idx[x0][y0]) indicating the reference line in which reference samples for prediction of the current block are located is first parsed, and a PCM flag (pcm_flag) indicating whether to apply PCM is then parsed. In this case, since the reference line index is parsed irrespective of whether PCM is applied or not, if the PCM is applied, the reference line index is parsed by the coding device even though the reference line index is not used, resulting in waste of data resources.

Further, referring to the signaling source code in Table 4 below, since the information (pcm_flag (cu)) for whether to apply PCM is identified after the information (extend_ref_line (cu)) for the reference line is identified, the information (extend_ref_line(cu)) for the reference line is parsed although not used, causing waste of data resources, as does the PCM.

The syntax and source code expressed by programming language below will be easily understood by those skilled in the art related to the embodiments of the disclosure. The video processing device and method according to an embodiment of the disclosure may be implemented in the form of a program executed by the following syntax and source code and as an electronic device that executes the program.

TABLE 3

Descriptor

coding_unit( x0, y0, cbWidth, cbHeight, treeType ) {

if( slice_typc != I ) {

| | |
|---|---|
| cu_skip_flag[ x0 ][ y0 ] | ae(v) |
| if( cu_skip_flag[ x0 ][ y0 ] == 0 ) | |

| | |
|---|---|
| pred_mode_flag | ae(v) |

}
if( CuPredMode[ x0 ][ y0 ] == MODE_INTRA ) {

if( treeType == SINGLE_TREE ∥ treeType == DUAL_TREE_LUMA ) {

if( ( y0 % CtbSizeY ) > 0 )

| | |
|---|---|
| intra_luma_ref_idx[ x0 ][ y0 ] | ae(v) |

}
if( pcm_enabled_flag &&

cbWidth >= MinIpcmCbSizeY &&
cbWidth <= MaxIpcmCbSizeY &&
cbHeight >= MinIpcmCbSizeY &&
cbHeight <= MaxIpcmCbSizeY )

| | |
|---|---|
| pcm_flag[ x0 ][ y0 ] | ae(v) |
| if( pcm flag[ x0 ][ y0 ] ) { | |

while( !byte_aligned( ) )

| | |
|---|---|
| pcm_alignment_zero_bit | f(1) |
| pcm_sample( x0, y0, cbWidth, cbHeight, treeType) | |

} else {

if( treeType == SINGLE_TREE ∥ treeType == DUAL_TREE_LUMA ) {

if (intra_luma_ref_idx[ x0 ][ y0 ] == 0)

| | |
|---|---|
| intra_luma_mpm_flag[ x0 ][ y0 ] | ae(v) |

if( intra_luma_mpm_flag[ x0 ][ y0 ] )

| | |
|---|---|
| intra_luma_mpm_idx[ x0 ][ y0 ] | ae(v) |

else

| | |
|---|---|
| intra_luma_mpm_remainder[ x0 ][ y0 ] | ae(v) |

}
if( treeType == SINGLE_TREE ∥ treeType == DUAL_TREE_CHROMA )

| | |
|---|---|
| intra_chroma_pred_mode[ x0 ][ y0 ] | ae(v) |

}

} else {/* MODE_INTER */
if( cu_skip_flag[ x0 ][ y0 ] ) {

if( sps_affine_enabled_flag && cbWidth >= 8 && cbHeight >= 8 &&

( MotionModelIdc[ x0 − 1 ][ y0 + cbHeight − 1 ] != 0 ∥

MotionModelIdc[ x0 − 1 ][ y0 + cbHeight ] != 0 ∥
MotionModelIdc[ x0 − 1 ][ y0 − 1 ] != 0 ∥
MotionModelIdc[ x0 + cbWidth − 1 ][ y0 − 1 ] != 0 ∥
MotionModelIdc[ x0 + cbWidth ][ y0 − 1 ]] != 0 ) )

| | |
|---|---|
| merge_affine_flag[ x0 ][ y0 ] | ae(v) |

if( merge_affine_flag[ x0 ][ y0 ] == 0 && MaxNumMergeCand > 1 )

| | |
|---|---|
| merge_idx[ x0 ][ y0 ] | ae(v) |

} else {

| | |
|---|---|
| merge_flag[ x0 ][ y0 ] | ae(v) |
| if( merge_flag[ x0 ][ y0 ] ) { | |
| if( sps affine enabled flag && cbWidth >= 8 && cbHeight >= 8 && | |

( MotionModelIdc[ x0 − 1 ][ y0 + cbHeight − 1 ] != 0 ∥

MotionModelIdc[ x0 − 1 ][ y0 + cbHeight ] != 0 ∥
MotionModelIdc[ x0 − 1 ][ y0 − 1 ] != 0 ∥
MotionModelIdc[ x0 + cbWidth 1 ][ y0 − 1 ] != 0 ∥

MotionModelIdc[ x0 + cbWidth ][ y0 − 1 ]] != 0 ) )

| | |
|---|---|
| merge_affine_flag[ x0 ][ y0 ] | ae(v) |

if( merge_affine_flag[ x0 ][ y0 ] == 0 && MaxNumMergeCand > 1 )

| | |
|---|---|
| merge_idx[ x0 ][ y0 ] | ae(v) |

} else {

| | |
|---|---|
| if( slice_type == B ) | ae(v) |

inter_pred_idc[ x0 ][ y0 ]

if( sps_affine_enabled_flag && cbWidth >=16 && cbHeight >= 16 ) {

| | |
|---|---|
| inter_affine_flag[ x0 ][ y0 ] | ae(v) |
| if( sps_affine_type_flag && inter_affine_flag[ x0 ][ y0 ] ) | |

| | |
|---|---|
| cu_affine_type_flag[ x0 ][ y0 ] | ae(v) |

}
if( inter_pred_idc[ x0 ][ y0 ] != PRED_L1 ) {

if( num_ref_idx_l0_active_minus1 > 0 )

| | |
|---|---|
| ref_idx_l0[ x0 ][ y0 ] | ae(v) |

mvd_coding( x0, y0, 0, 0 )
if( MotionModelIdc[ x0 ][ y0 ] > 0 )

mvd_coding( x0, y0, 0, 1 )

if(MotionModelIdc[ x0 ][ y0 ] > 1 )

mvd_coding( x0, y0, 0, 2 )

| | |
|---|---|
| mvp_l0_flag[ x0 ][ y0 ] | ae(v) |

} else {

MvdL0[ x0 ][ y0 ][ 0 ] = 0
MvdL0[ x0 ][ y0 ][ 1 ] = 0

}
if( inter_pred_idc[ x0 ][ y0 ] != PRED_L0 ) {

if( num_ref_idx_l1_active_minus1 > 0 )

| | |
|---|---|
| ref_idx_l1[ x0 ][ y0 ] | ae(v) |

if( mvd_l1_zero_flag && inter_pred_idc[ x0 ][ y0 ] == PRED_BI ) {

MvdL1[ x0 ][ y0 ][ 0 ] = 0
MvdL1[ x0 ][ y0 ][ 1 ] = 0
MvdCpL1[ x0 ][ y0 ][ 0 ][ 0 ] = 0
MvdCpL1[ x0 ][ y0 ][ 0 ][ 1 ] = 0
MvdCpL1[ x0 ][ y0 ][ 1 ][ 0 ] = 0
MvdCpL1[ x0 ][ y0 ][ 1 ][ 1 ] = 0
MvdCpL1[ x0 ][ y0 ][ 2 ][ 0 ] = 0
MvdCpL1[ x0 ][ y0 ][ 2 ][ 1 ] = 0

} else {

mvd_coding( x0, y0, 1, 0)

if( MotionModelIdc[ x0 ][ y0 ] > 0 )

mvd_coding( x0, y0, 1, 1 )

if(MotionModelIdc[ x0 ][ y0 ] > 1 )

mvd_coding( x0, y0, 1, 2 )

| | |
|---|---|
| mvp_l1 _flag[ x0 ][ y0 ] | ae(v) |

} else {

MvdL1[ x0 ][ y0 ][ 0 ] = 0
MvdL1[ x0 ][ y0 ][ 1 ] = 0

}
if( sps_amvr_enabled_flag && inter_affine_flag == 0 &&

( MvdL0[ x0 ][ y0 ][ 0 ] != 0 ∥ MvdL0[ x0 ][ y0 ][ 1 ] != 0 ∥

MvdL1[ x0 ][ y0 ][ 0 ] != 0 ∥ MvdL1[ x0 ][ y0 ][ 1 ]!= 0 ) )

| | |
|---|---|
| amvr_mode[ x0 ][ y0 ] | ae(v) |

}

}

}
if( CuPredMode[ x0 ][ y0 ] != MODE_INTRA && cu_skip_flag[ x0 ][ y0 ] ==

0 )

| | |
|---|---|
| cu_cbf | ae(v) |

if( cu_cbf)

transform_tree( x0, y0, cbWidth, cbHeight, treeType )

}

TABLE 4
void CABACReader::pcm_flag( CodingUnit& cu )
{

const SPS& sps = *cu.cs−>sps;
if( !sps.getUsePCM( ) ∥ cu.lumaSize( ).width > (1 << sps.getPCMLog2MaxSize( )) |
cu.lumaSize( ).width < (1 << sps.getPCMLog2MinSize ( )) )
{

cu.ipcm = false;
return;

}
cu.ipcm = ( m_BinDecoder.decodeBinTrm( ) );

}
bool CABACReader::coding_unit( CodingUnit &cu, Partitioner &partitioner, CUCtx& cuCtx )
{

CodingStructure& cs = *cu.cs;

#if JVET_L0293_CPR

cs.chType = partitioner.chType;

#endif

// transquant bypass flag
if( cs.pps−>getTransquantBypassEnabledFlag( ) )
{

cu_transquant_bypass_flag( cu );

}
// skip flag

#if JVET_L0293_CPR

if (!cs.slice−>isIntra( ) && cu.Y( ).valid( ))

#else

if( !cs.slice−>isIntra( ))

#endif

{

cu_skip_flag( cu );

}
// skip data
if( cu.skip )
{

| | |
|---|---|
| cs.addTU | ( cu, partitioner.chType ); |
| PredictionUnit& | pu = cs.addPU( cu, partitioner.chType ); |

| | |
|---|---|
| MergeCtx | mrgCtx; |

prediction_unit ( pu, mrgCtx );
return end_of_ctu( cu, cuCtx );

}
// prediction mode and partitioning data
pred_mode ( cu );
cu.partSize = SIZE_2Nx2N;
// --> create PUs
CU::addPUs( cu );
extend_ref_line( cu );
// pcm samples
if( CU::isIntra(cu) && cu.partSize == SIZE_2Nx2N )
{

pcm_flag( cu );
if( cu.ipcm )
{

TransformUnit& tu = cs.addTU( cu, partitioner.chType );
pcm_samples( tu );
return end_of_ctu( cu, cuCtx );

}

}
// prediction data ( intra prediction modes / reference indexes + motion vectors )
cu_pred_data( cu );
// residual data ( coded block flags + transform coefficient levels )
cu_residual( cu, partitioner, cuCtx );
// check end of cu
return end_of_ctu( cu, cuCtx );

}

According to an embodiment of the disclosure, there is proposed a method for signaling the MRL index of the current block only when it is in not the PCM mode. Further, according to an embodiment of the disclosure, there is proposed a method for performing prediction with reference to the MRL index when the PCM mode is not applied (i.e., when intra prediction is applied) after identifying whether the PCM mode is applied in the decoding process of a video signal. In the disclosure, the current block is an arbitrary block in the picture processed by the encoding device 100 or the decoding device 200 and may correspond to a coding unit or a prediction unit.

Table 5 below illustrates an example coding unit syntax according to an embodiment. The encoding device 100 may configure and encode a coding unit syntax including information as shown in Table 5. The encoding device 100 may store and transmit the encoded coding unit syntax in the form of a bitstream. The decoding device 200 may obtain (parse) the encoded coding unit syntax from the bitstream.

TABLE 5

Descriptor

coding_unit( x0, y0, cbWidth, cbHeight, treeType ) {
if( slice type != I ) {

| | |
|---|---|
| cu_skip_flag[ x0 ][ y0 ] | ae(v) |
| if( cu_skip_flag[ x0 ][ y0 ] == 0 ) | |

| | |
|---|---|
| pred_mode_flag | ae(v) |

}
if( CuPredMode[ x0 ][ y0 ] == MODE_INTRA ) {
if( pcm_enabled_flag &&

cbWidth >= MinIpcmCbSizeY &&
cbWidth <= MaxIpcmCbSizeY &&
cbHeight >= MinIpcmCbSizeY &&
cbHeight <= MaxIpcmCbSizeY )

| | |
|---|---|
| pcm_flag[ x0 ][ y0 ] | ae(v) |

if( pcm_flag[ x0 ][ y0 ] ) {

while( !byte_aligned( ) )

| | |
|---|---|
| pcm_alignment_zero_bit | f(1) |
| pcm_sample( x0, y0, cbWidth, cbHeight, treeType) | |

} else {
if( treeType == SINGLE_TREE ∥ treeType == DUAL_TREE_LUMA ) {

if( ( y0 % CtbSizeY ) > 0 )

| | |
|---|---|
| intra_luma_ref_idx[ x0 ][ y0 ] | ae(v) |

if (intra_luma_ref_idx[ x0 ][ y0 ] == 0)

| | |
|---|---|
| intra_luma_mpm_flag[ x0 ][ y0 ] | ae(v) |

if( intra_luma_mpm_flag[ x0 ][ y0 ] )

| | |
|---|---|
| intra_luma_mpm_idx[ x0 ][ y0 ] | ae(v) |

else

| | |
|---|---|
| intra_luma_mpm_remainder[ x0 ][ y0 ] | ae(v) |

}
if( treeType == SINGLE_TREE ∥ treeType == DUAL_TREE_CHROMA )

| | |
|---|---|
| intra_chroma_pred_mode[ x0 ][ y0 ] | ae(v) |

}

} else { /* MODE_INTER */

if( cu_skip_flag[ x0 ][ y0 ] ) {

if( sps_affine_enabled_flag && cbWidth >= 8 && cbHeight >= 8 &&

( MotionModelIdc[ x0 − 1 ][ y0 + cbHeight − 1 ] != 0 ∥

MotionModelIdc[ x0 − 1 ][ y0 + cbHeight ] != 0 ∥
MotionModelIdc[ x0 − 1 ][ y0 − 1 ] != 0 ∥
MotionModelIdc[ x0 + cbWidth − 1 ][ y0 − 1 ] ! = 0 ∥
MotionModelIdc[ x0 + cbWidth ][ y0 − 1 ]] 1= 0 ) )

| | |
|---|---|
| merge_affine_flag[ x0 ][ y0 ] | ae(v) |

if( merge_affine_flag[ x0 ][ y0 ] == 0 && MaxNumMergeCand > 1 )

| | |
|---|---|
| merge_idx[ x0 ][ y0 ] | ae(v) |

} else {

| | |
|---|---|
| merge_flag[ x0 ][ y0 ] | ae(v) |
| if( merge_flag[ x0 ][ y0 ] ) { | |

if( sps_affine_enabled_flag && cbWidth >= 8 && cbHeight >= 8 &&

( MotionModelIdc[ x0 − 1 ][ y0 + cbHeight − 1 ] != 0 ∥

MotionModelIdc[ x0 − 1 ][ y0 + cbHeight ] != 0 ∥
MotionModelIdc[ x0 − 1 ][ y0 − 1 ] != 0 ∥
MotionModelIdc[ x0 + cbWidth − 1 ][y0 − 1 ] != 0 ∥
MotionModelIdc[ x0 + cbWidth ][ y0 − 1 ]] != 0 ) )

| | |
|---|---|
| merge_affine_flag[ x0 ][ y0 ] | ae(v) |

if(_merge_affine_flag[ x0 ][ y0 ] == 0 && MaxNumMergeCand > 1 )

| | |
|---|---|
| merge_idx[ x0 ][ y0 ] | ae(v) |

} else {

if( slice_type == B )

| | |
|---|---|
| inter_pred_idc[ x0 ][ y0 ] | ae(v) |

if( sps_affine_enabled_{——}flag && cbWidth >=16 && cbHeight >= 16 ) {

| | |
|---|---|
| inter_affine_flag[ x0 ][ y0 ] | ae(v) |
| if( sps_affine_type_flag && inter_affine_flag[ x0 ][ y0 ] ) | ae(v) |

cu_affine_type_flag[ x0 ][ y0 ]

}
if( inter_pred_idc[ x0 ][ y0 ] != PRED_L1 ) {

if( num_ref_idx_l0_active_minus1 > 0 )

| | |
|---|---|
| ref_idx_l0[ x0 ][ y0 ] | ae(v) |

mvd_coding) x0, y0, 0, 0 )
if( MotionModelIdc[ x0 ][ y0 ] > 0 )

mvd_coding( x0, y0, 0, 1 )

if(MotionModelIdc[ x0 ][ y0 ] > 1 )

mvd_coding( x0, y0, 0, 2 )

| | |
|---|---|
| mvp_l0_flag[ x0 ][ y0 ] | ae(v) |

} else {

MvdL0[ x0 ][ y0 ][ 0 ] = 0
MvdL0[ x0 ][ y0 ][ 1 ] = 0

}
if( inter_pred_idc[ x0 ][ y0 ] != PRED_L0 ) {

if( num_ref_idx_l1_active_minus1 > 0 )

| | |
|---|---|
| ref_idx_l1[ x0 ][ y0 ] | ae(v) |

if( mvd_l1_zero_flag && inter_pred_idc[ x0 ][ y0 ] == PRED_BI ) {

MvdL1[ x0 ][ y0 ][ 0 ] = 0
MvdL1[ x0 ][ y0 ][ 1 ] = 0
MvdCpL1[ x0 ][ y0 ][ 0 ][ 0 ] = 0
MvdCpL1[ x0 ][ y0 ][ 0 ][ 1 ] = 0
MvdCpL1[ x0 ][ y0 ][ 1 ][ 0 ] = 0
MvdCpL1[ x0 ][ y0 ][ 1 ][ 1 ] = 0
MvdCpL1[ x0 ][ y0 ][ 2 ][ 0 ] = 0
MvdCpL1[ x0 ][ y0 ][ 2 ][ 1 ] = 0

} else {

mvd_coding( x0, y0, 1, 0 )

if( MotionModelIdc[ x0 ][ y0 ] > 0 )

mvd_coding( x0, y0, 1, 1 )

if(MotionModelIdc[ x0 ][ y0 ] > 1 )

mvd_coding( x0, y0, 1, 2 )

| | |
|---|---|
| mvp_l1_flag[ x0 ][ y0 ] | ae(v) |

{ else {

MvdL1[ x0 ][ y0 ][ 0 ] = 0
MvdL1[ x0 ][ y0 ][ 1 ] = 0

}
if( sps_amvr_enabled_flag && inter_affine_flag == 0 &&

( MvdL0[ x0 ][ y0 ][ 0 ] != 0 ∥ MvdL0[ x0 ][ y0 ][ 1 ] != 0 ∥

MvdL1[ x0 ][ y0 ][ 0 ] != 0 ∥ MvdL1[ x0 ][ y0 ][ 1 ] != 0 ) )

| | |
|---|---|
| amvr_mode[ x0 ][ y0 ] | ae(v) |

}

}

}

if(!pcm_flag[ x0 ][ y0 ]) {

if( CuPredMode[ x0 ][ y0 ] != MODE_INTRA && cu_skip_flag[ x0 ][ y0 ] ==
0 )

| | |
|---|---|
| cu_cbf | ae(v) |

if( cu_cbf )

transform_tree( x0, y0, cbWidth, cbHeight, treeType )

}
}

Referring to Table 5, when the prediction mode of the current block (coding unit) is an intra prediction mode (CuPredMode[x0][y0]==MODE_INTRA) and a condition under which PCM may be applied is met, the coding device may identify the flag (PCM flag) (pcm_flag) indicating whether PCM is applied. When it is identified from the PCM flag that PCM is not applied (if the PCM flag is ‘0’), the coding device may identify the index (MRL index) (intra_luma_ref_idx) indicating which one among a plurality of neighboring reference lines located within a certain sample distance from the current block is used for prediction of the current block. The coding device may generate the prediction sample of the current block from the reference sample of the reference line indicated by the MRL index. Table 13 below shows an example coding unit signaling source code according to an embodiment of the disclosure.

In an embodiment, a plurality of reference lines for prediction of the current block may be parsed only when they are included in the same CTU as the current block. For example, as shown in the syntax of Table 13, if the result of a modular operation (%) of the Y-axis size (CtbSizeY) of the CTU to which the current block belongs to for the Y position value (y0) of the top left sample within the current block is greater than 0 ((y0% CtbSizeY)>0), it may be determined that the plurality of reference lines are in the same CTU as the current block. This is because when the current block is located on the top boundary of the CTU, the resultant value of the modular operation becomes 0, and thus, the samples located on the top side of the current block are included in a CTU different from the current block. If the current block is not located on the top boundary of the CTU, the MRL index may be parsed.

TABLE 6
void CABACReader::pcm_flag(CodingUnit& cu )
{

const SPS& sps = *cu.cs−>sps;
if( !sps.getUsePCM( ) ∥ cu.lumaSize( ).width > (1 << sps.getPCMLog2MaxSize( )) ∥

cu.lumaSize( ).width < (1 << sps.getPCMLog2MinSize( )) )

{

cu.ipcm = false;
return;

}
cu.ipcm = ( m_BinDecoder.decodeBinTrm( ) );

}
bool CABACReader::coding_unit( CodingUnit &cu, Partitioner &partitioner, CUCtx& cuCtx )
{

CodingStructure& cs = *cu.cs;

#if JVET_L0293_CPR

cs.chType = partitioner.chType;

#endif

// transquant bypass flag
if( cs.pps−>getTransquantBypassEnabledFlag( ) )
{

cu_transquaut_bypass_flag( cu );

}
// skip flag

#if JVET_L0293_CPR

if (!cs.slice−>isIntra( ) && cu.Y( ).valid( ))

#else

if( !cs.slice−>isIntra( ) )

#endif

{

cu_skip_flag( cu );

}
// skip data
if( cu.skip )
{

| | |
|---|---|
| cs.addTU | ( cu, partitioner.chType ); |
| PredictionUnit& | pu = cs.addPU( cu, partitioner.chType ); |

| | |
|---|---|
| MergeCtx | mrgCtx; |

prediction_unit ( pu, mrgCtx );
return end_of_ctu( cu, cuCtx );

}
// prediction mode and partitioning data
pred_mode ( cu );
cu.partSize = SIZE_2Nx2N;
// --> create PUs
CU::addPUs( cu );
// pcm samples
if( CU::isIntra(cu) && cu.partSize = SIZE_2Nx2N )
{

pcm_flag( cu );
if( cu.ipcm )
{

TransformUnit& tu = cs.addTU( cu, partitioner.chType );
pcm_samples( tu);
return end_of_ctu( cu, cuCtx );

}

}
extend_ref_line( cu );
// prediction data ( intra prediction modes / reference indexes + motion vectors )
cu_pred_data( cu );
// residual data ( coded block flags + transform coefficient levels )
cu_residual( cu, partitioner, cuCtx );
// check end of cu
return end_of_ctu( cu, cuCtx );

}

Referring to Table 6, the coding device may identify whether the PCM mode is applied based on the PCM flag (pcm_flag (cu)) and then identify the MRL index (extend_ref_line(cu)). For example, the MRL index may be parsed only when the PCM flag is ‘0’.

As shown in Tables 5 and 6, it may be identified whether the PCM mode is applied through the PCM flag (i.e., whether intra prediction is applied) and, if the PCM mode is not applied (i.e., when intra prediction is applied), it may be identified through the MRL index which reference line is used. Therefore, as the MRL index need not be parsed or signaled although the PCM mode is applied, it is possible to reduce signaling overhead and coding complexity.

FIG. 13 is a flowchart illustrating a video data processing method according to an embodiment of the disclosure.

Each of the operations of FIG. 13 is an example intra prediction process upon encoding or decoding video data and may be performed by the intra prediction unit 185 of the encoding device 100 and the intra prediction unit 265 of the decoding device 200.

According to an embodiment of the disclosure, an image signal processing method may include the step S1310 of determining whether a PCM mode in which a sample value of a current block in video data is transferred via a bitstream is applied, the step S1320 of identifying a reference index related to a reference line located within a predetermined distance from the current block based on the PCM mode being not applied, and the step S1330 of generating a prediction sample of the current block based on a reference sample included in the reference line related to the reference index.

More specifically, in step S1310, the video data processing device (encoding device or decoding device, collectively referred to herein as a coding device) may determine whether the PCM mode is applied to the current block. For example, the coding device may determine whether the PCM mode is applied through a flag (PCM flag) indicating whether to apply the PCM mode. For example, when the PCM flag is ‘0’, the coding device may determine that the PCM mode is not applied, and when the PCM flag is ‘1’, determine that the PCM mode is applied. Here, the PCM mode refers to a mode in which the sample value of the current block is directly transmitted from the encoding device 100 to the decoding device 200 through a bitstream. If the PCM mode is applied, the decoding device 200 may derive the sample value of the current block from the bitstream transferred from the encoding device 100 without prediction or transform process. The current block is a block unit in which processing is performed by the coding device and may correspond to a coding unit or a prediction unit.

In step S1320, when it is identified that the PCM mode is not applied, the coding device may identify the reference index related to the reference line located within a predetermined distance from the current block. For example, when the PCM flag is ‘0’ (when the PCM mode is not applied), the coding device may parse the reference index indicating the line where the reference sample for intra prediction of the current block is located. Meanwhile, when the PCM flag is ‘1’ (when the PCM mode is applied), the coding device may determine a sample value for the current block without intra prediction.

In an embodiment of the disclosure, the reference index may indicate one of a plurality of reference lines located within a predetermined distance from the current block. Here, the plurality of reference lines may include a plurality of upper reference lines positioned on a top boundary of the current block or a plurality of reference lines positioned on a left side of a left boundary of the current block.

For example, the plurality of reference lines may include four reference lines positioned on the top of the current block having a width W and a height H and four reference lines positioned on the left of the current block as illustrated in FIG. 12. For example, the plurality of reference lines may include a first reference line indicated by hatching corresponding to the 0th MRL index (mrl_idx) (or reference index) in FIG. 12, a second reference line indicated in dark gray corresponding to the 1st MRL index, a third reference line indicated by dots corresponding to the 2nd MRL index, and a fourth reference line indicated in light gray corresponding to the 3rd MRL index.

In an embodiment, the plurality of reference lines for prediction of the current block may be used only when they are included in the same CTU as the current block. For example, as shown in the syntax of Table 5, if the result of a modular operation (%) of the Y-axis size (CtbSizeY) of the CTU to which the current block belongs to for the Y position value (y0) of the top left sample of the current block is not 0, the coding device may determine that the plurality of reference lines are in the same CTU as the current block. This is because when the current block is located on the top boundary of the CTU, the resultant value of the modular operation becomes 0, and thus, the samples located on the top side of the current block are included in a CTU different from the current block.

Meanwhile, the reference index for indicating the reference line in which the reference sample to be used for prediction of the current block is located may be included in the bitstream and transmitted from the encoding device 100 to the decoding device 200 only when a specific condition is met. In other words, if the PCM mode is applied, the reference index (MRL index) is not coded and thus is excluded from the bitstream, and may not be transmitted from the encoding device 100 to the decoding device 200. For example, as in the signaling source code of Table 6, when the PCM flag is 1, the coding device may code the sample value of the current block according to the PCM mode and terminate the coding for the current block. Further, referring to Table 6, when the PCM flag is 0, the coding device may code the reference index (extend_ref_line) for the reference line.

As described above, it is possible to reduce the decoding complexity of the decoding device 200 and the signaling overhead of the encoding device 100 by variably coding and signaling the reference index for the reference line depending on whether PCM is applied.

In step S1330, the coding device may generate the prediction sample of the current block based on the reference sample included in the reference line related to the reference index. In other words, the coding device may determine a sample value for each pixel position included in the current block using the intra prediction mode and the reference sample of the reference line indicated by the reference index. For example, when the reference index (MRL index) is 1, the coding device applies the intra prediction mode from the samples of the reference line (the line of samples indicated in dark gray) spaced apart from the current block by 1 sample distance in FIG. 12, thereby determining the sample value for the current block.

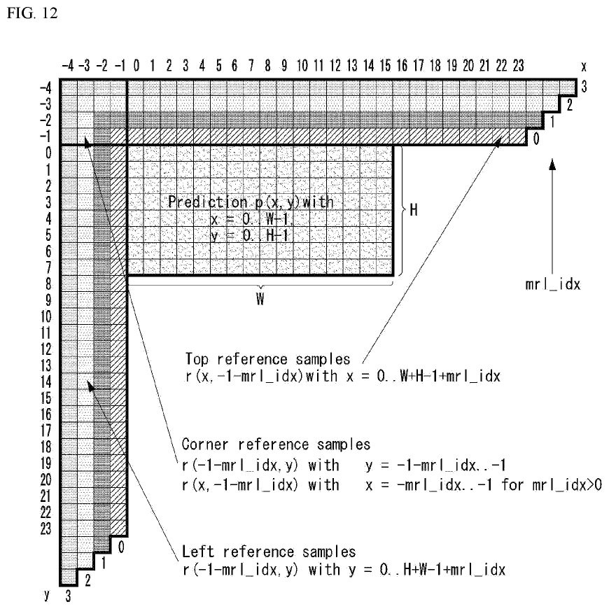

FIG. 14 illustrates an example video data encoding process according to an embodiment of the disclosure. Each operation of FIG. 14 may be performed by the intra prediction unit 185 of the encoding device 100.

In step S1410, the encoding device 100 may determine whether to apply the PCM mode to the current block to be encoded. Here, the PCM mode may refer to a mode in which the sample value of the current block is directly transferred from the encoding device 100 to the decoding device 200 without prediction or transform for the current block. The encoding device 100 may determine whether to apply the PCM mode considering the RD cost.

When it is determined to apply the PCM mode, the encoding device 100 may proceed to step S1450. In step S1450, the encoding device 100 may encode the sample value of the current block according to the PCM mode. In other words, the encoding device 100 may encode the sample value of the current block and include it in the bitstream while omitting a prediction and transform process according to the PCM mode.

When the PCM mode is applied, the encoding device 100 may omit coding of information related to prediction including the reference index. In particular, the encoding device 100 may omit coding for the reference index indicating the reference line according to the application of the MRL. For example, as in the signaling source code of Table 6, when the PCM flag is 1, the coding device may code the sample value of the current block according to the PCM mode and terminate the coding for the current block.

For example, as in the signaling source code of Table 6, when the PCM flag is 1, the coding device may code the sample value of the current block according to the PCM mode and terminate the coding for the current block.

If it is determined not to apply the PCM mode, the encoding device 100 may proceed to step S1420. In step S1420, the encoding device 100 may determine a reference sample and an intra prediction mode for intra prediction of the current block. For example, the encoding device 100 may determine a reference sample and an intra prediction mode considering the RD cost. Thereafter, in step S1430, the encoding device 100 may encode prediction information and residual information.

Referring to Table 6, when the PCM flag is 0, the coding device may code the reference index (extend_ref_line) for the reference line.

In an embodiment, when determining the reference sample, the encoding device 100 may determine not only a reference sample directly adjacent to the current block, but also reference samples located in a plurality of reference lines within a predetermined distance from the current block. Further, the encoding device 100 may code the reference index (MRL index) indicating the reference line where the reference sample for prediction of the current block is located.

In an embodiment, the reference index may indicate one of a plurality of reference lines located within a predetermined distance from the current block. Here, the plurality of reference lines may include a plurality of upper reference lines positioned on a top boundary of the current block or a plurality of reference lines positioned on a left side of a left boundary of the current block.

For example, the plurality of reference lines may include four reference lines positioned on the top of the current block having a width W and a height H and four reference lines positioned on the left side of the current block as illustrated in FIG. 12. For example, the plurality of reference lines may include a first reference line indicated by hatching corresponding to the 0th MRL index (mrl_idx) (or reference index) in FIG. 12, a second reference line indicated in dark gray corresponding to the 1st MRL index, a third reference line indicated by dots corresponding to the 2nd MRL index, and a fourth reference line indicated in light gray corresponding to the 3rd MRL index.

In an embodiment, the plurality of reference lines for prediction of the current block according to the MRL may be used for prediction of the current block only when they are included in the same coding tree unit as the current block. For example, as shown in the syntax of Table 6, if the result of a modular operation (%) of the Y-axis size (CtbSizeY) of the CTU to which the current block belongs to for the Y position value (y0) of the top left sample within the current block is greater than 0 ((y0% CtbSizeY)>0), it may be determined that the plurality of reference lines are in the same CTU as the current block. This is because when the current block is located on the top boundary of the CTU, the resultant value of the modular operation becomes 0, and thus, the samples located on the top side of the current block are included in a CTU different from the current block. If the current block is not located on the top boundary of the CTU, the MRL index may be parsed.

As described above, the encoding device 100 may reduce coding complexity and signaling overhead by variably coding and signaling the reference index for the reference line depending on whether PCM is applied.

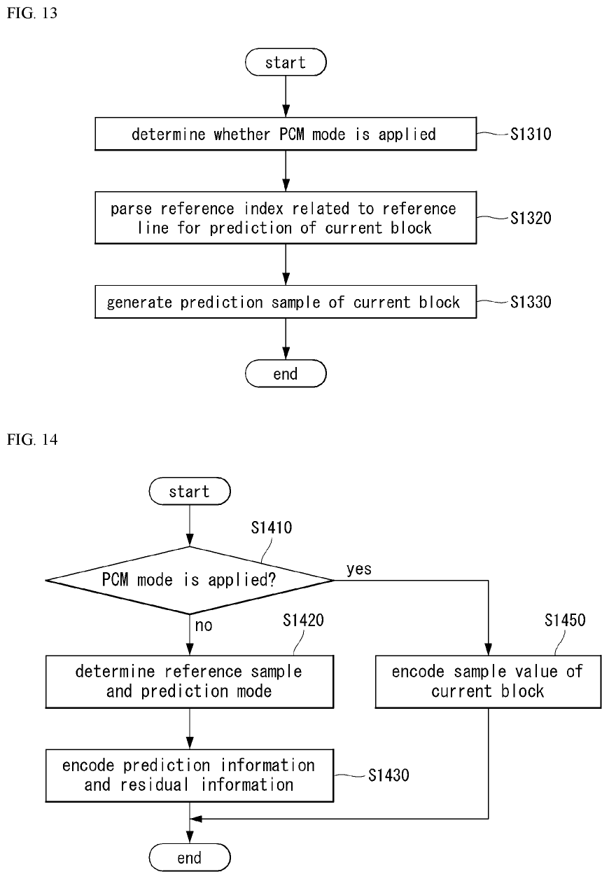

FIG. 15 illustrates another example video data decoding process according to an embodiment of the disclosure. Each of the operations of FIG. 15 is an example intra prediction process upon decoding video data and may be performed by the intra prediction unit 265 of the decoding device 200.

In step S1510, the decoding device 200 determines whether the PCM flag indicating whether the PCM mode is applied to the current block is 1. In other words, the decoding device 200 may determine whether the PCM mode is applied to the current block. Here, the PCM mode may refer to a mode in which the sample value of the current block is directly transferred from the encoding device 100 to the decoding device 200 without prediction or transform for the current block. Here, the current block is a block unit in which processing is performed by the decoding device 200 and may correspond to a coding unit or a prediction unit.

If the PCM flag is 1 (when the PCM mode is applied), the decoding device 200 may proceed to step S1550. In step S1550, the decoding device 200 may determine the sample value of the current block according to the PCM mode. For example, the decoding device 200 may directly derive the sample value of the current block from the bitstream transmitted from the encoding device 100 and may omit a prediction or transform process. When the sample value of the current block is derived according to the PCM mode, the decoding device 200 may terminate the decoding procedure for the current block and perform decoding on a subsequent block to be processed.

If the PCM flag is 0 (if the PCM mode is not applied), the decoding device 200 may proceed to step S1520. In step S1520, the decoding device 200 may parse the MRL index. Here, the reference index means an index indicating the reference line where the reference sample used for prediction of the current block is located. The reference index may be referred to as an MRL index and may be expressed as ‘intra_luma_ref_idx’ in Table 5.

In step S1530, the decoding device 200 may determine the reference line related to the reference index in the current picture. In other words, the decoding device 200 may determine the reference line indicated by the reference index among the reference lines adjacent to the current block.

In an embodiment, the reference index may indicate one of a plurality of reference lines located within a predetermined distance from the current block. Here, the plurality of reference lines may include a plurality of upper reference lines positioned on a top boundary of the current block or a plurality of reference lines positioned on a left side of a left boundary of the current block.

For example, the plurality of reference lines may include four reference lines positioned on the top of the current block having a width W and a height H and four reference lines positioned on the left side of the current block as illustrated in FIG. 12. For example, the plurality of reference lines may include a first reference line indicated by hatching corresponding to the 0th MRL index (mrl_idx) (or reference index) in FIG. 12, a second reference line indicated in dark gray corresponding to the 1st MRL index, a third reference line indicated by dots corresponding to the 2nd MRL index, and a fourth reference line indicated in light gray corresponding to the 3rd MRL index.

In an embodiment, the plurality of reference lines for prediction of the current block may be used only when they are included in the same CTU as the current block. For example, as shown in the syntax of Table 5, if the result of a modular operation (%) of the Y-axis size (CtbSizeY) of the CTU to which the current block belongs to for the Y position value (y0) of the top left sample within the current block is not 0, the decoding device 200 may determine that the plurality of reference lines are in the same CTU as the current block. This is because when the current block is located on the top boundary of the CTU, the resultant value of the modular operation becomes 0, and thus, the samples located on the top side of the current block are included in a CTU different from the current block.

Meanwhile, the reference index for indicating the reference line in which the reference sample to be used for prediction of the current block is located may be included in the bitstream and transmitted from the encoding device 100 to the decoding device 200 only when a specific condition is met. In other words, if the PCM mode is applied, the reference index (MRL index) is not coded and thus is excluded from the bitstream, and may not be transmitted from the encoding device 100 to the decoding device 200. For example, as in the signaling source code of Table 6, when the PCM flag is 1, the decoding device 200 may code the sample value of the current block according to the PCM mode and terminate the coding for the current block. Further, referring to Table 6, when the PCM flag is 0, the decoding device 200 may code the reference index (extend_ref_line) for the reference line.

As described above, it is possible to reduce the decoding complexity of the decoding device 200 and the signaling overhead of the encoding device 100 by variably coding and signaling the reference index for the reference line depending on whether PCM is applied.

In operation S1540, the decoding device 200 may determine the prediction sample value of the current block from the reference sample of the reference line. In other words, the decoding device 200 may determine a sample value for each pixel position included in the current block using the intra prediction mode and the reference sample of the reference line indicated by the reference index. For example, when the reference index (MRL index) is 1, the decoding device 200 applies the intra prediction mode from the samples of the reference line (the line of samples indicated in dark gray) spaced apart from the current block by 1 sample distance in FIG. 12, thereby determining the sample value for the current block. Thereafter, the decoding device 200 may terminate the coding procedure for the current block and perform coding on a subsequent block to be processed.

### SPECIFIC APPLICATION EXAMPLES

The embodiments of the disclosure may be implemented and performed on a processor, microprocessor, controller, or chip. For example, the functional units shown in each figure may be implemented and performed on a processor, microprocessor, controller, or chip.

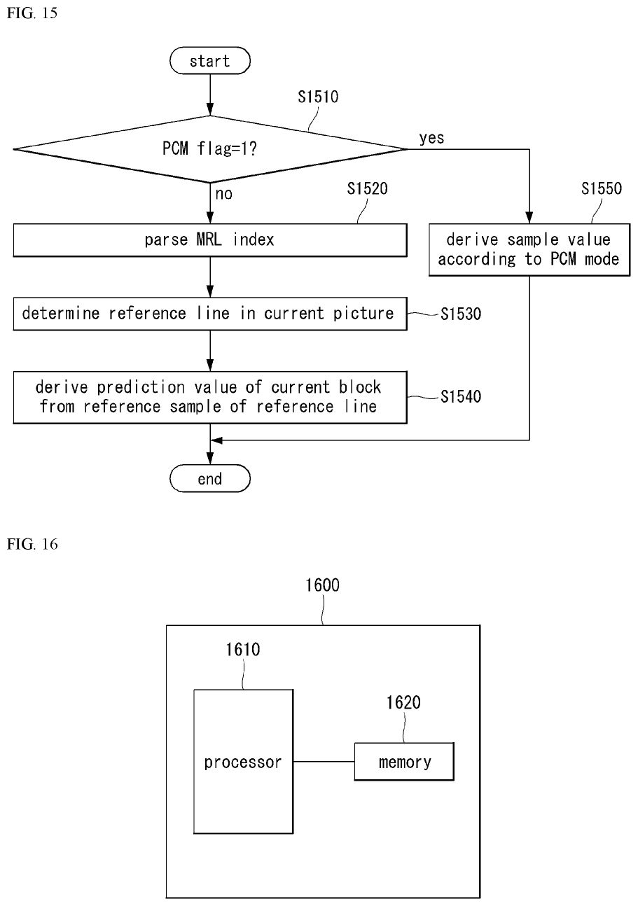

FIG. 16 is a block diagram illustrating an example device for processing video data according to an embodiment of the disclosure. The video data processing device of FIG. 16 may correspond to the encoding device 100 of FIG. 2 or the decoding device 200 of FIG. 3.

According to an embodiment of the disclosure, the video data processing device 1600 may include a memory 1620 for storing video data and a processor 1610 coupled with the memory to process video data.

According to an embodiment of the disclosure, the processor 1610 may be configured as at least one processing circuit for processing video data and may execute instructions for encoding or decoding video data to thereby process video signals. In other words, the processor 1610 may encode raw video data or decode encoded video data by executing the above-described encoding or decoding methods.

According to an embodiment of the disclosure, a device for processing video data using intra prediction may include a memory 1620 storing video data and a processor 1610 coupled with the memory 1620. According to an embodiment of the disclosure, the processor 1610 may be configured to determine whether a PCM mode in which a sample value of a current block in video data is transferred via a bitstream is applied, identify a reference index related to a reference line for intra prediction of the current block based on the PCM mode being not applied, and generate a prediction sample of the current block based on a reference sample included in a reference line related to the reference index.

According to an embodiment of the disclosure, the processor 1610 may identify whether the PCM mode is applied and, upon identifying that the PCM mode is not applied, identify the reference index and perform prediction, thereby preventing the reference line index from being unnecessarily parsed although prediction is not performed by the PCM mode and hence reducing the time for the processor 1610 to process video data.

In an embodiment, the processor 1610 may identify a flag indicating whether the PCM mode is applied. Here, the flag indicating whether the PCM mode is applied may be referred to as a PCM flag. In other words, the processor 1610 may identify whether the PCM mode is applied to the current block through the PCM flag. For example, when the PCM flag is 0, the PCM mode is not applied to the current block, and when the PCM flag is 1, the PCM mode may be applied to the current block. For example, as shown in the syntax of Table 5, when the PCM flag is 1, the processor 1610 may derive a sample value of the current block according to the PCM mode. When the PCM flag is 0, the processor 1610 may identify the reference index (MRL index) indicating the reference line where the reference sample for prediction of the current block is located.

In an embodiment, the reference index may indicate one of a plurality of reference lines located within a predetermined distance from the current block. The reference index may correspond to the MRL index of FIG. 12 or ‘intra_luma_ref_idx’ of Tables 3 and 5.

According to an embodiment, the plurality of reference lines may include a plurality of upper reference lines positioned on a top boundary of the current block or a plurality of reference lines positioned on a left side of a left boundary of the current block. For example, the reference lines where the reference samples used for prediction of the current block are located may include reference lines composed of reference samples located within a distance of 4 samples from the left and top boundaries of the current block, as illustrated in FIG. 12.

According to an embodiment, the plurality of reference lines for prediction of the current block may be included in the same coding tree unit as the current block. For example, the processor 1610 may identify whether the current block is located on the top boundary of the CTU before parsing the reference index and, if the current block is not located on the top boundary of the CTU, parse the reference index. For example, as shown in the syntax of Table 5, if the result of a modular operation (%) of the Y-axis size (CtbSizeY) of the CTU to which the current block belongs to for the Y position value (y0) of the top left sample within the current block is not 0, it may be determined that the plurality of reference lines are in the same CTU as the current block.

In an embodiment, the reference index may be transmitted from the encoding device 100 to the decoding device 200 when the PCM mode is not applied. The decoding device 200 may derive the sample value of the current block from the bitstream transmitted from the encoding device 100. The current block is a block unit in which processing is performed by the coding device and may correspond to a coding unit or a prediction unit.

In other words, if the PCM mode is applied, the reference index (MRL index) is not coded and thus is excluded from the bitstream, and may not be transmitted from the encoding device 100 to the decoding device 200. For example, as in the signaling source code of Table 13, when the PCM flag is 1, the coding device may code the sample value of the current block according to the PCM mode and terminate the coding for the current block. Further, referring to Table 13, when the PCM flag is 0, the coding device may code the reference index (extend_ref_line) for the reference line.

Bitstream

The encoded information (e.g., encoded video/image information) derived by the encoding device 100 based on the above-described embodiments of the disclosure may be output in the form of a bitstream. The encoded information may be transmitted or stored in NAL units, in the form of a bitstream. The bitstream may be transmitted over a network, or may be stored in a non-transitory digital storage medium. Further, as described above, the bitstream is not directly transmitted from the encoding device 100 to the decoding device 200, but may be streamed/downloaded via an external server (e.g., a content streaming server). The network may include, e.g., a broadcast network and/or communication network, and the digital storage medium may include, e.g., USB, SD, CD, DVD, Bluray, HDD, SSD, or other various storage media.

The processing methods to which embodiments of the disclosure are applied may be produced in the form of a program executed on computers and may be stored in computer-readable recording media. Multimedia data with the data structure according to the disclosure may also be stored in computer-readable recording media. The computer-readable recording media include all kinds of storage devices and distributed storage devices that may store computer-readable data. The computer-readable recording media may include, e.g., Bluray discs (BDs), universal serial bus (USB) drives, ROMs, PROMs, EPROMs, EEPROMs, RAMs, CD-ROMs, magnetic tapes, floppy disks, and optical data storage. The computer-readable recording media may include media implemented in the form of carrier waves (e.g., transmissions over the Internet). Bitstreams generated by the encoding method may be stored in computer-readable recording media or be transmitted via a wired/wireless communication network.

The embodiments of the disclosure may be implemented as computer programs by program codes which may be executed on computers according to an embodiment of the disclosure. The computer codes may be stored on a computer-readable carrier.

The above-described embodiments of the disclosure may be implemented by a non-transitory computer-readable medium storing a computer-executable component configured to be executed by one or more processors of a computing device. According to an embodiment of the disclosure, the computer-executable component may be configured to determine whether a PCM mode in which a sample value of a current block in video data is transferred via a bitstream is applied, identify a reference index related to a reference line for intra prediction of the current block based on the PCM mode being not applied, and generate a prediction sample of the current block based on a reference sample included in a reference line related to the reference index. Further, according to an embodiment of the disclosure, the computer-executable component may be configured to execute operations corresponding to the video data processing method described with reference to FIGS. 13 and 14.

The decoding device 200 and the encoding device 100 to which the disclosure is applied may be included in a digital device. The digital devices encompass all kinds or types of digital devices capable of performing at least one of transmission, reception, processing, and output of, e.g., data, content, or services. Processing data, content, or services by a digital device includes encoding and/or decoding the data, content, or services. Such a digital device may be paired or connected with other digital device or an external server via a wired/wireless network, transmitting or receiving data or, as necessary, converting data.

The digital devices may include, e.g., network TVs, hybrid broadcast broadband TVs, smart TVs, internet protocol televisions (IPTVs), personal computers, or other standing devices or mobile or handheld devices, such as personal digital assistants (PDAs), smartphones, tablet PCs, or laptop computers.

As used herein, “wired/wireless network” collectively refers to communication networks supporting various communication standards or protocols for data communication and/or mutual connection between digital devices or between a digital device and an external server. Such wired/wireless networks may include communication networks currently supported or to be supported in the future and communication protocols for such communication networks and may be formed by, e.g., communication standards for wired connection, including USB (Universal Serial Bus), CVBS (Composite Video Banking Sync), component, S-video (analog), DVI (Digital Visual Interface), HDMI (High Definition Multimedia Interface), RGB, or D-SUB and communication standards for wireless connection, including Bluetooth, RFID (Radio Frequency Identification), IrDA (infrared Data Association), UWB (Ultra-Wideband), ZigBee, DLNA (Digital Living Network Alliance), WLAN (Wireless LAN) (Wi-Fi), Wibro (Wireless broadband), Wimax (World Interoperability for Microwave Access), HSDPA (High Speed Downlink Packet Access), LTE (Long Term Evolution), or Wi-Fi Direct.

Hereinafter, when simply referred to as a digital device in the disclosure, it may mean either or both a stationary device or/and a mobile device depending on the context.

Meanwhile, the digital device is an intelligent device that supports, e.g., broadcast reception, computer functions, and at least one external input, and may support, e.g., e-mail, web browsing, banking, games, or applications via the above-described wired/wireless network. Further, the digital device may include an interface for supporting at least one input or control means (hereinafter, input means), such as a handwriting input device, a touch screen, and a spatial remote control. The digital device may use a standardized general-purpose operating system (OS). For example, the digital device may add, delete, amend, and update various applications on general-purpose OS kernel, thereby configuring and providing a user-friendlier environment.

The above-described embodiments regard predetermined combinations of the components and features of the disclosure. Each component or feature should be considered as optional unless explicitly mentioned otherwise. Each component or feature may be practiced in such a manner as not to be combined with other components or features. Further, some components and/or features may be combined together to configure an embodiment of the disclosure. The order of the operations described in connection with the embodiments of the disclosure may be varied. Some components or features in an embodiment may be included in another embodiment or may be replaced with corresponding components or features of the other embodiment. It is obvious that the claims may be combined to constitute an embodiment unless explicitly stated otherwise or such combinations may be added in new claims by an amendment after filing.

When implemented in firmware or hardware, an embodiment of the disclosure may be implemented as a module, procedure, or function performing the above-described functions or operations. The software code may be stored in a memory and driven by a processor. The memory may be positioned inside or outside the processor to exchange data with the processor by various known means.

It is apparent to one of ordinary skill in the art that the disclosure may be embodied in other specific forms without departing from the essential features of the disclosure. Thus, the above description should be interpreted not as limiting in all aspects but as exemplary. The scope of the disclosure should be determined by reasonable interpretations of the appended claims and all equivalents of the disclosure belong to the scope of the disclosure.

### INDUSTRIAL APPLICABILITY

Hereinabove, the preferred embodiments of the present disclosure are disclosed for an illustrative purpose and hereinafter, modifications, changes, substitutions, or additions of various other embodiments will be made within the technical spirit and the technical scope of the present disclosure disclosed in the appended claims by those skilled in the art.

1. A method for processing video data, the method comprising:
determining whether a pulse code modulation (PCM) mode is applied in which a sample value of a current block of the video data is transmitted via a bitstream;
parsing from the bitstream an index related to a reference line for intra prediction of the current block, based on the PCM mode being not applied; and
generating a prediction sample of the current block based on a reference sample included in a reference line related to the index.

2. The method of claim 1, wherein the index indicates one of a plurality of reference lines positioned within a predetermined distance from the current block.

3. The method of claim 2, wherein the plurality of reference lines include a plurality of upper reference lines positioned on a top boundary of the current block or a plurality of reference lines positioned on a left side of a left boundary of the current block.

4. The method of claim 1, wherein the plurality of reference lines are included in the same coding tree unit as the current block.

5. The method of claim 1, wherein determining whether the PCM mode is applied includes identifying a flag indicating whether the PCM mode is applied.

6. The method of claim 1, wherein the index is transmitted from an encoding device to a decoding device when the PCM mode is not applied.

7. The method of claim 1, wherein the current block corresponds to a coding unit or a prediction unit.

8. A method for encoding video data, comprising:
determining whether a pulse code modulation (PCM) mode is applied in which a sample value of a current block of the video data is transmitted via a bitstream;
determining a reference sample and an intra prediction mode for intra prediction of the current block, based on the PCM mode being not applied; and
encode prediction information and residual information for the current block,
wherein the encoding the prediction information and the residual information comprises:
generating an index related to a reference line where the reference sample for intra prediction is located.

9. The method of claim 8, wherein the index indicates one of a plurality of reference lines positioned within a predetermined distance from the current block.

10. The method of claim 9, wherein the plurality of reference lines include a plurality of upper reference lines positioned on a top boundary of the current block or a plurality of reference lines positioned on a left side of a left boundary of the current block.

11. The method of claim 8, wherein the plurality of reference lines are included in the same coding tree unit as the current block.

12. The method of claim 8, further comprising:
encoding a flag indicating whether the PCM mode is applied.

13. The method of claim 8, wherein the index is generated when the PCM mode is not applied.

14. The method of claim 8, wherein the current block corresponds to a coding unit or a prediction unit.

15. A non-transitory computer-readable storage medium for storing a bitstream generated by the method of claim 8.
